(19) United States
(12) Patent Application Publication
(10) Pub. No.: US 2017/0149257 A1
(43) Pub. Date: May 25, 2017

(54) FIELD CHARGING UNIT FOR VARIOUS BATTERIES IN MULTIPLE DEPLOYABLE DEVICES

(71) Applicant: ENGINEERING DESIGN, INC., Camarillo, CA (US)

(72) Inventors: Marcos Liu, Thousand Oaks, CA (US); Alejandro Salazar, Reseda, CA (US); Daniel Ensenat, Camarillo, CA (US)

(73) Assignee: ENGINEERING DESIGN, INC., Camarillo, CA (US)

(21) Appl. No.: 15/339,685

(22) Filed: Oct. 31, 2016

Related U.S. Application Data
(60) Provisional application No. 62/249,149, filed on Oct. 30, 2015.

(51) Int. Cl. H02J 7/00; B64F 5/60; B64C 39/02

(52) U.S. Cl. CPC H02J 7/0021; H02J 7/0045; B64C 39/024; B64F 5/60; B64C 2201/042

(57) ABSTRACT

A device for charging various batteries in multiple deployable units, such as small unmanned aircraft systems and their ancillary devices. The device provides an efficient means of charging multiple unmanned aerial vehicle batteries using a high output power, while simultaneously charging multiple Ground Control Station batteries and an external device, such as a laptop or tablet. The device provides a precise readout in real time of each cell's charge, the battery's overall charge, and the percentage of charge.

### RELATED APPLICATION

This application claims priority to U.S. Provisional Application No. 62/249,149, filed on Oct. 30, 2015, which is incorporated by reference herein in its entirety.

### BACKGROUND OF THE DISCLOSURE

Field of the Disclosure

Described herein is a device relating to battery chargers, and specifically, charging units for batteries used in unmanned aircraft operations.

Description of the Related Art

Small unmanned aircraft systems (SUAS) and ancillary components operated in conjunction therewith are powered by various types of batteries. Examples of SUAS are the Raven and the PUMA systems, both of which are regularly used by the United States Military. The Raven battery, as shown in FIG. 3, is a 6-cell 2-parallel battery, also known as a 6S 2P battery, containing two parallels each with six cells in series. The PUMA battery, as shown in FIG. 4, is a 6-cell 6-parallel battery, also known as a 6S 6P battery, which comprises 6 parallels each with six cells in series. Additional SUAS batteries used within the field include the BB-2590/U model GCS battery shown in FIG. 5, and the BB-2557/U model GCS battery shown in FIG. 6.

Some charging devices for these batteries known in the art, such as the original equipment manufacture charger shown in FIG. 1, have filament fuses that require replacement once the fuse is blown. They typically have one or two battery charging outputs with an output power of about 400 Watts, allowing a simultaneous charge of up to two batteries. The two charging stations can be compatible with Raven and PUMA batteries, but are not compatible with Vertical Take-Off and Landing (VTOL) SUAS batteries like those shown in FIG. 2, which are used in the InstantEye system, another SUAS system that is used by the United States Military. With these charging devices, fully charging a Raven battery can take 60 to 90 minutes, and fully charging a PUMA battery can take longer than 120 minutes. Known charging devices provide limited information to users in the field. For example, some charges have four lights to approximate the state of charge, a fault light to indicate if the battery is faulty, and another light to indicate a charge in process.

### SUMMARY OF THE DISCLOSURE

Described herein are embodiments of a device for recharging various batteries in multiple deployable units, such as SUAS and their ancillary components. The charging device contains multiple battery charge outputs for simultaneous charging of batteries. Each charging port for the SUAS batteries comprises a charge lead with a set amount of pin connectors, for example 10. However, an alternate amount of pin connectors may be used. In one embodiment, seven of the ten pin connectors are connected to charger balance ports, which balance the charges of each cell within the battery to allow even charging. The seven pin connectors allow batteries with up to six cells in series to be balanced. Multiple GCS ports as well as a USB port are each on independent circuits and can all be charging units simultaneously while SUAS batteries are being charged.

The charging device can be supplied by AC or DC current. As SUAS batteries run only on DC current, the charging device contains at least one AC/DC converter. A charger powers the charge leads with a high power to allow fast SUAS battery charges.

In one embodiment, the charging device comprises a tester lead that can test in real time various aspects of an SUAS battery before being charged, such as the overall voltage and charge percent of the battery, the individual voltage and charge percent of each cell, and which of the cells have the highest and lowest charges in the battery. The battery model can be manually or automatically selected from numerous battery models preprogrammed into the charging device with their respective charging specifications. In some embodiments, a “bump collector” within the charging device can be used to scan the battery, which can eliminate the need to manually select the battery model. Pre-sensing the battery allows the charger to automatically select the battery model and corresponding charging specifications from a database or look-up table for the user when the battery is “bumped”.

After sensing or inputting the battery type, a SUAS battery may be connected to a charge lead. The number of SUAS batteries is selected, and the charger mode (e.g., charge, discharge, storage) is selected. Preparing batteries for storage entails either charging or discharging each cell to the optimal level of charge for long-term storage, for example 50%.

These and other further features and advantages of the disclosure would be apparent to those skilled in the art from the following detailed description, taking together with the accompanying drawings, in which:

### BRIEF DESCRIPTION OF THE DRAWINGS

FIG. 1 is an image of an original equipment manufacture charger for the SUAS batteries which is known in the art;

FIG. 2 is an image of an InstantEye battery which is known in the art;

FIG. 3 is an image of Raven batteries which are known in the art;

FIG. 4 is an image of a PUMA battery which is known in the art;

FIG. 5 is an image of a BB-2590/U model GCS battery which is known in the art;

FIG. 6 is an image of BB-2557/U model GCS batteries which are known in the art;

FIG. 7 illustrates the connector orientation of a printed circuit board assembly (PCBA) unit according to the present disclosure;

FIG. 8 illustrates holes for connectors by size of a PCBA unit according to the present disclosure;

FIG. 9 illustrates a silkscreen top for a PCBA unit according to the present disclosure;

FIG. 10 illustrates a solder mask top for a PCBA unit according to the present disclosure;

FIG. 11 illustrates a top view of a first copper layer in a PCBA unit according to the present disclosure;

FIG. 12 illustrates a top view of a second copper layer in a PCBA unit according to the present disclosure;

FIG. 13 illustrates a solder mask bottom for a PCBA unit according to the present disclosure;

FIG. 13b illustrates holes in the top of a PCBA unit according to the present disclosure;

FIG. 14 illustrates the circuit connections of a PCBA unit according to the present disclosure;

FIG. 15 illustrates a top perspective view of a charging device according to the present disclosure;

FIG. 16 illustrates a closed carrying case containing a charging device according to the present disclosure;

FIG. 17 illustrates a perspective view of a charging device according to the present disclosure;

FIG. 18 illustrates a bottom perspective view of a charging device according to the present disclosure;

FIG. 19 illustrates a top close-up view of a charging device according to the present disclosure;

FIGS. 20-21 illustrate an internal view of a charging device according to the present disclosure;

FIG. 22 illustrates a block diagram of a charging device according to the present disclosure;

FIGS. 23-29 illustrate displays of a tester screen according to the present disclosure;

FIGS. 30a-30c illustrate displays of model type options on a charger screen according to the present disclosure;

FIGS. 31-38 illustrate displays of a charger screen according to the present disclosure; and

FIG. 39 illustrates both sides of a PCBA unit according to the present disclosure.

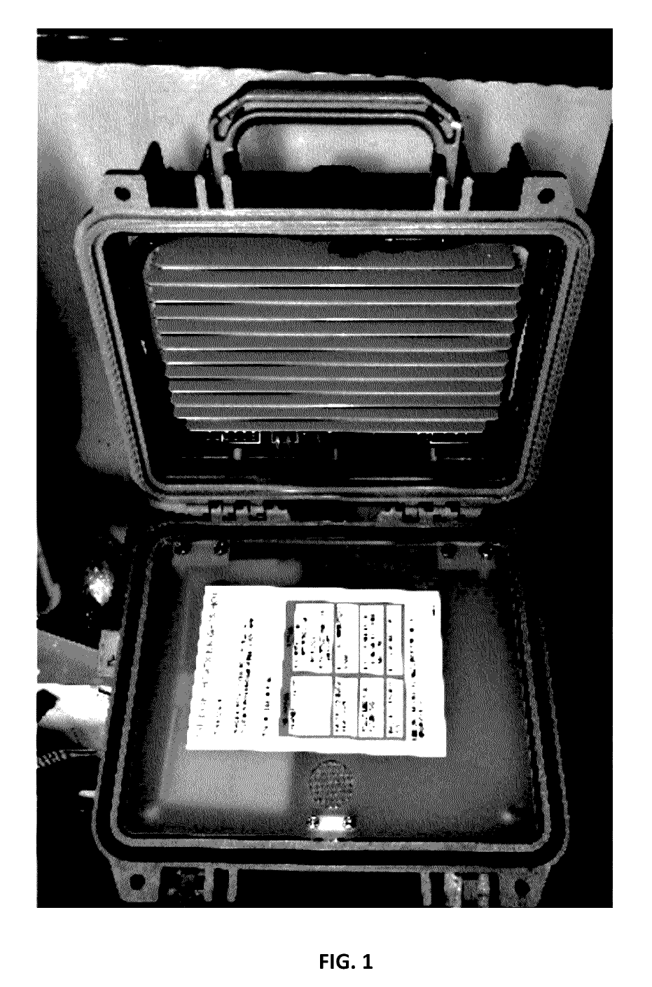

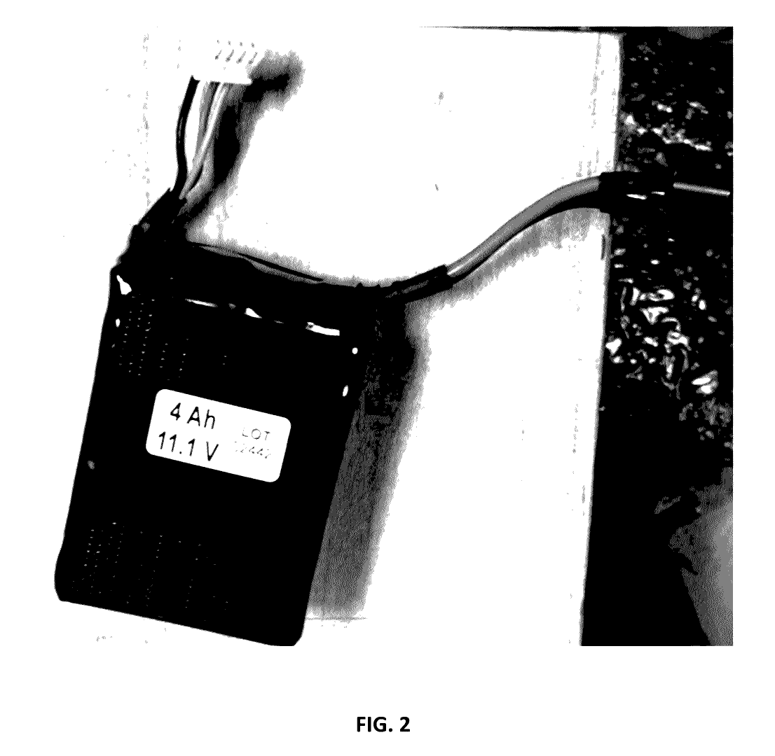

### DETAILED DESCRIPTION OF THE DISCLOSURE

Throughout this description, the preferred embodiment and examples illustrated should be considered as exemplars, rather than as limitations on the present disclosure. As used herein, the term “disclosure,” “device,” “present disclosure” or “present device” refers to any one of the embodiments of the disclosure described herein, and any equivalents. Furthermore, reference to various feature(s) of the “disclosure,” “device,” “present disclosure” or “present device” throughout this document does not mean that all claimed embodiments or methods must include the referenced feature(s).

It is also understood that when an element or feature is referred to as being “on” or “adjacent” another element or feature, it can be directly on or adjacent the other element or feature or intervening elements or features may also be present. Furthermore, relative terms such as “outer”, “above”, “lower”, “below”, and similar terms, may be used herein to describe a relationship of one feature to another. It is understood that these terms are intended to encompass different orientations in addition to the orientation depicted in the figures.

Although the ordinal terms first, second, etc. may be used herein to describe various elements or components, these elements or components should not be limited by these terms. These terms are only used to distinguish one element or component from another element or component. Thus, a first element or component discussed below could be termed a second element or component without departing from the teachings of the present disclosure.

Embodiments of the disclosure are described herein with reference to different views and illustrations that are schematic illustrations of idealized embodiments of the disclosure. As such, variations from the shapes of the illustrations as a result, for example, of manufacturing techniques and/or tolerances are expected. Embodiments of the disclosure should not be construed as limited to the particular shapes of the regions illustrated herein but are to include deviations in shapes that result, for example, from manufacturing.

The devices described herein may be used for charging SUAS batteries and the batteries of their ancillary components. Although reference is made throughout the disclosure to SUAS, it is understood that the charging devices and systems disclosed herein may be used with larger unmanned aircraft systems that might not be characterized as SUAS.

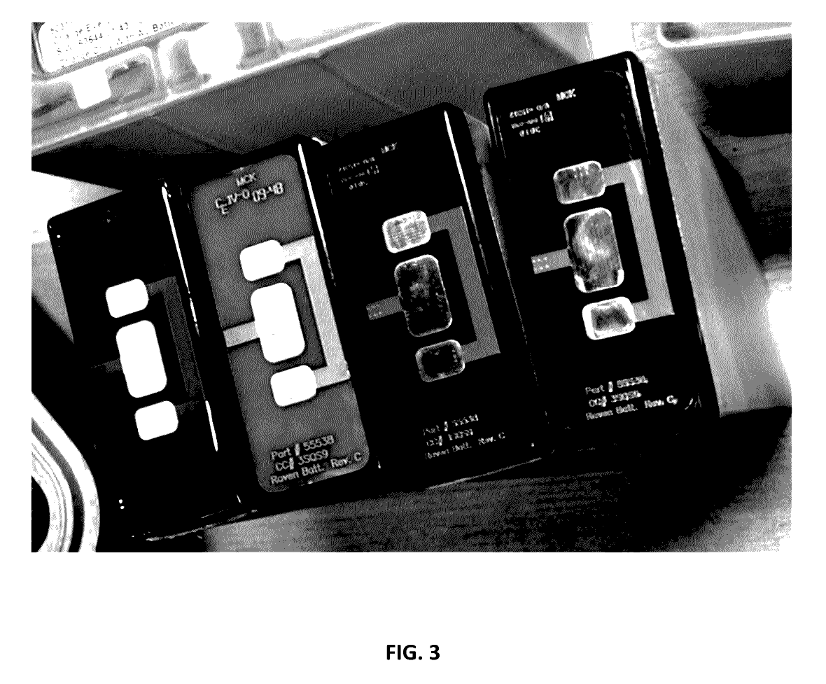

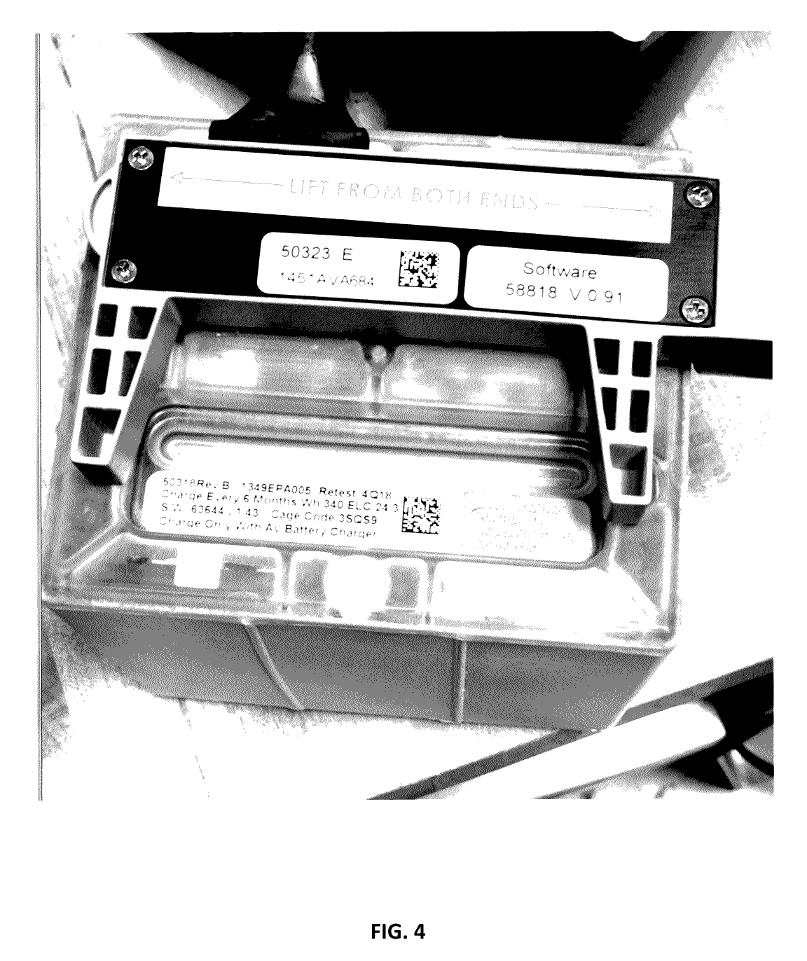

The charging device comprises multiple battery charge outputs for simultaneous charging of batteries. Some charge outputs, such as the SUAS charger ports, comprise charge leads each with a set amount of pin connectors, for example, ten. However, an alternate amount of pin connectors may be employed. The output power is high, such as approximately 1340 Watts, for example, in some embodiments to allow for fast charging. In such an embodiment, a Raven battery, such as those shown in FIG. 3, can be fully charged in about 30 minutes, and a PUMA battery, as shown in FIG. 4, can be fully charged in about 60 minutes. Four PUMA batteries can simultaneously charge in about two hours total.

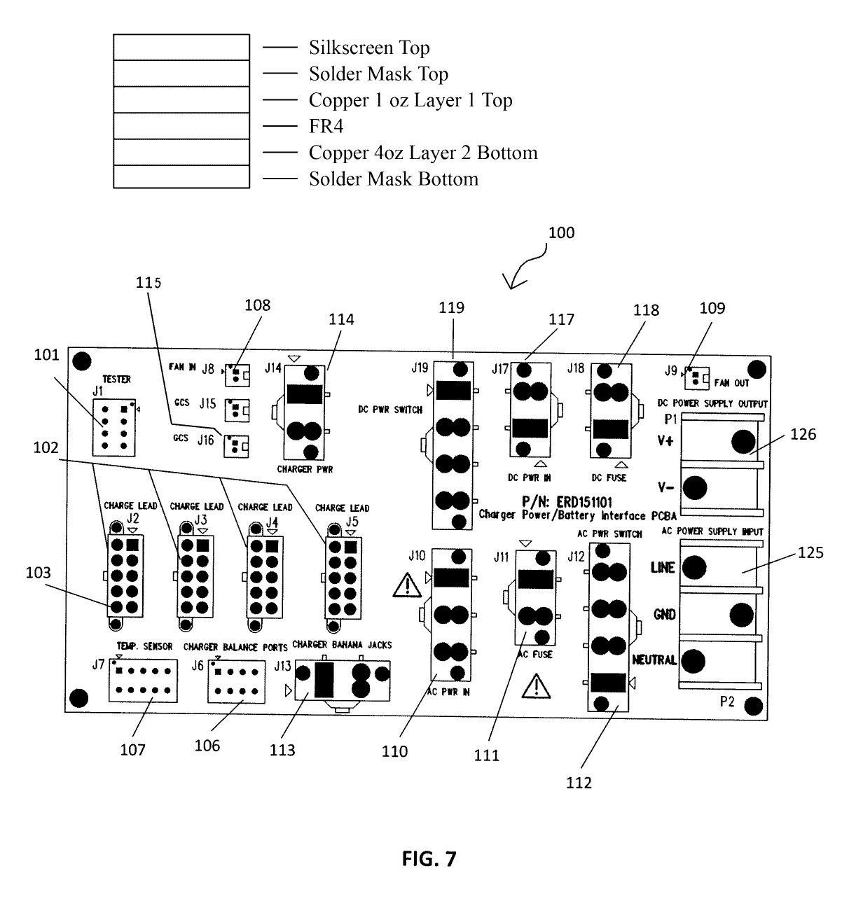

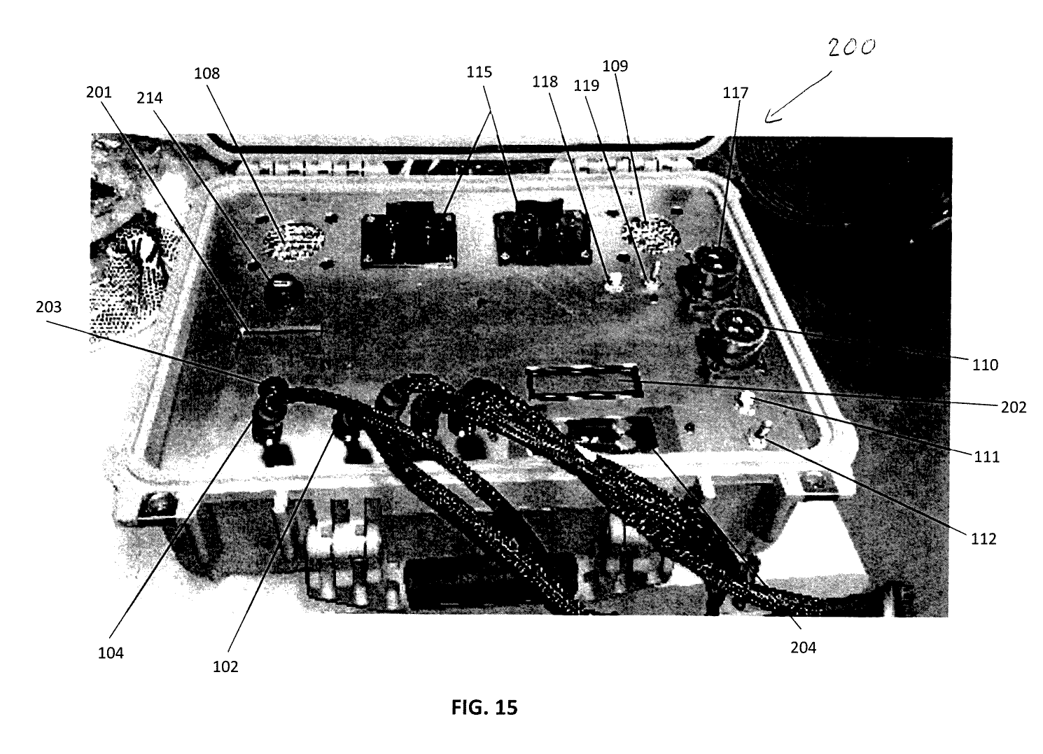

FIG. 7 is a schematic diagram showing an exemplary embodiment of a connector layout for use in charging units described herein, particularly the charging unit 200 shown in FIG. 15. The layout includes a battery tester 101 and four charge leads 102, each with ten pin connectors 103. Each charge lead 102 is connected to a SUAS charger port. Although four charge leads 102 are displayed, the charging device may contain more or less than four charge leads 102. Two of the ten pin connectors 103 connect to the power supply. Seven of the other ten pin connectors 103 are coupled to charger balance ports 106, which allow for equalization of charge among the individual cells within each battery being charged while the battery is connected to a charge lead 102. A balance cycle occurs during the process, such as during the last ten percent of the charge cycle. If cell charges are unequal, the balancing wires equally distribute the current between the cells to ensure an even charge among the cells. The seven balancing wires are capable of balancing a battery with six or fewer cells in series.

Not all SUAS batteries that are operable with the charging device require all seven balancing wires. The InstantEye battery, for example, is a three-cell battery and only uses four of the seven balancing wires. Other embodiments may include more or fewer balancing wires and/or adapters to accommodate batteries having various numbers of cells. The last pin connector 103 may be set up for a variety of functions, such as, for example, reading temperature by being connected to a temperature sensor 107. The last pin connector 103 may also be nonfunctional.

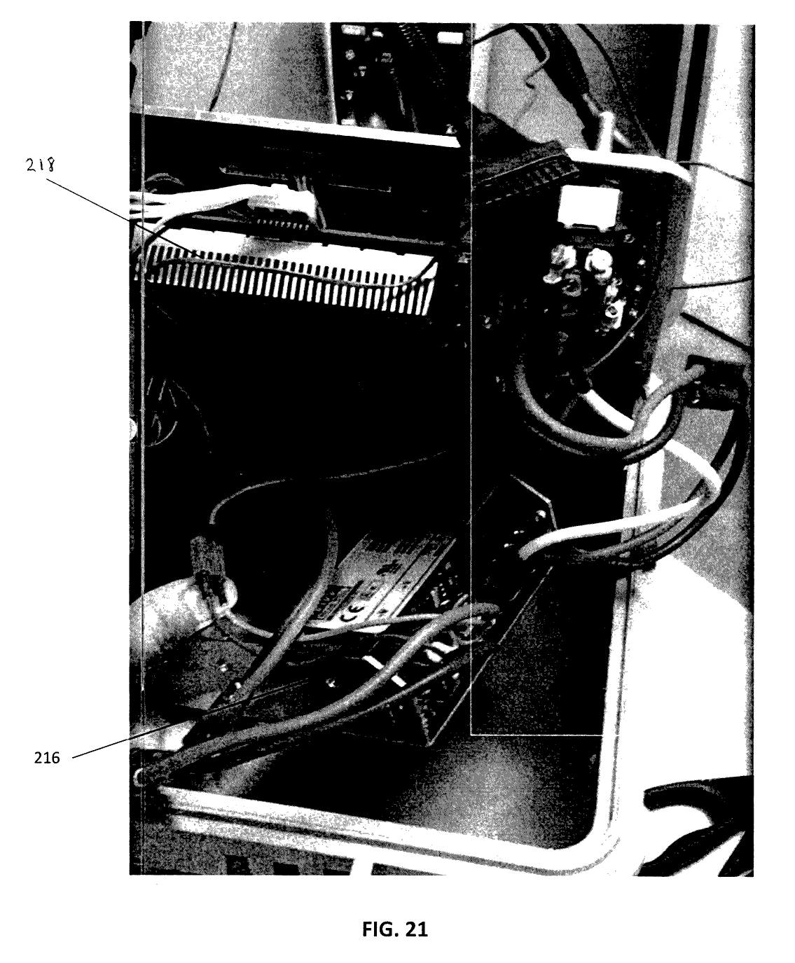

The charging unit 200 is capable of being powered by AC or DC current. The AC power input 110 receives a three-prong plug from an AC power source, such as a wall electrical outlet and is connected to an AC fuse 111. An AC/DC converter, as shown in FIG. 21, is required with an AC power supply because the SUAS batteries are charged with DC power. When the power supply to the charging device is AC, the current travels from the AC power input 110 to the AC input to converter, where the AC/DC converter 216 converts the current to DC, which then leaves the converter DC output 125 and travels to the charger. From the charger, the current then travels to the charge leads 102.

The charge leads 102 receive DC current, either from the DC power input 117 or the converter DC output 126, which are both connected to a DC fuse 118. It then sends a high power to the charge leads 102. Some embodiments produce an output power that is greater than 1000 watts. Some embodiments produce an output power of about 1200 watts or greater. In other embodiments, the output power can be approximately 1340 watts or greater.

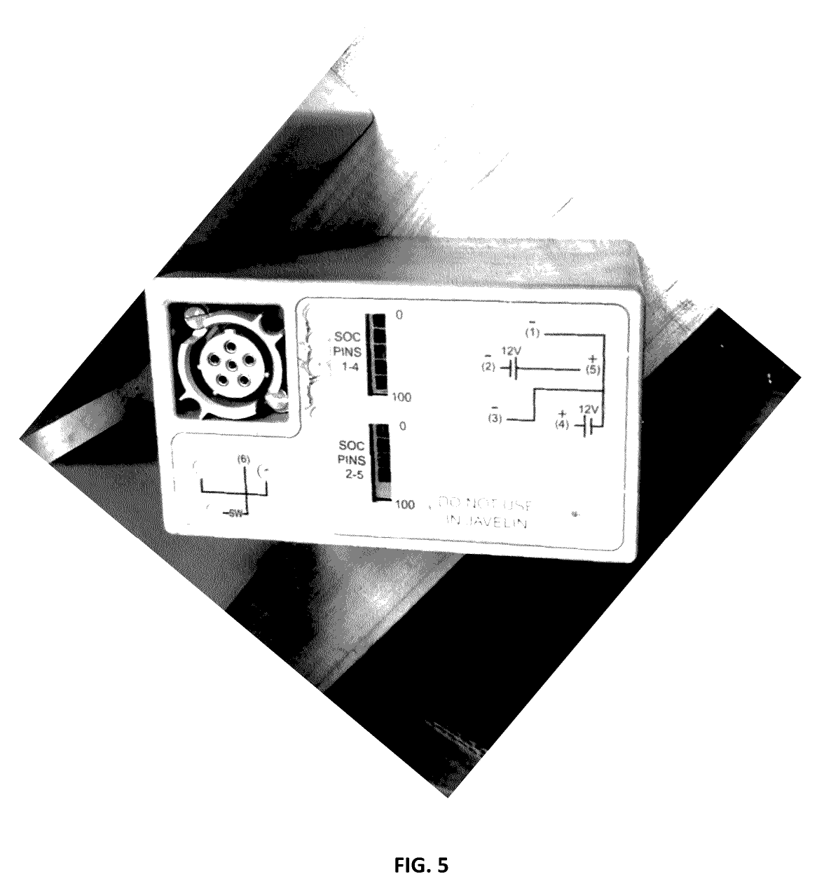

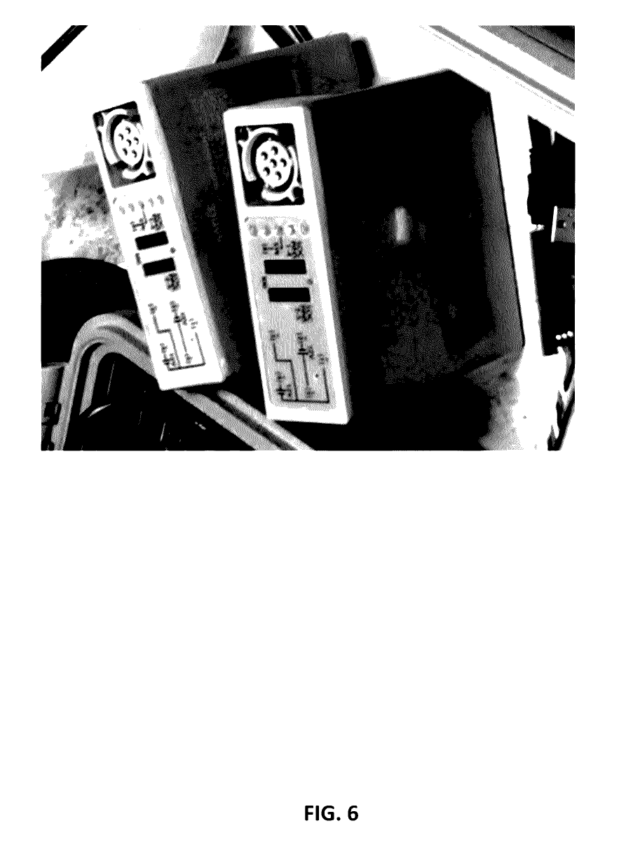

The charging unit 200 can comprise additional charge outputs. Some embodiments include a banana jack port 113, which can charge devices capable of connecting to the charging unit 200 via banana jacks. Another additional charger port 114 can also be included as desired. Some embodiments include two Ground Control Station (GCS) ports 115 for GCS batteries, including batteries for the hand controller, RF unit antenna, hub, and laptop with an adaptor. The GCS battery comprises two separate lithium ion sections. The BB-2557/U model, such as the one shown in FIG. 6, contains eight cells. The BB-2590/U model, as shown in FIG. 5, contains sixteen cells. Both models have the same battery voltage. FIG. 7 shows two GCS ports 115, although the charging unit 200 may have more or less than two. The GCS ports 115 are connected to a charger circuit separate from the charge leads 102. The embodiment shown in FIG. 7 allows for four SUAS batteries and two GCS batteries to be charged simultaneously. Further, the charging device has a high output power, such as 1344 Watts, enabling double the amount of SUAS batteries to simultaneously charge and at about half the time as other known charging devices. The charging unit 200 can display when the GCS ports 115 are on standby, beginning to charge, charging, or have completed the charge. This can be displayed, for example, by one or more indicator lights, a display screen, a digital read-out screen, audio output, or any other output means.

The charging device 200 can incorporate active and/or passive cooling systems, such as a heat sink 218 shown in FIG. 21. The charging unit 200 may comprise two fans, the intake fan 108 and the outtake fan 109. However, more or fewer fans may be used. Both the intake fan 108 and the outtake fan 109 are located in the surface of the charging device 100, such that the intake fan 108 provides air flow into the inside of the charging device 200 and the outtake fan 109 provides air flow from the inside of the charging device 200 to the outside. An internal heat sink 218 is also included. The heat sink 218 can be in thermal contact with the AC/DC converter 216 and/or the charge leads 102.

In one embodiment, the charger comprises three fans: an intake fan 108, an outtake fan 109, and an internal fan positioned to create airflow across an internal heat sink 218. The internal fan may also be positioned to move air toward the outtake fan 109 or elsewhere.

In another embodiment, both fans that are located in the surface of the charger are outtake fans. One or more optional internal fans may also be included.

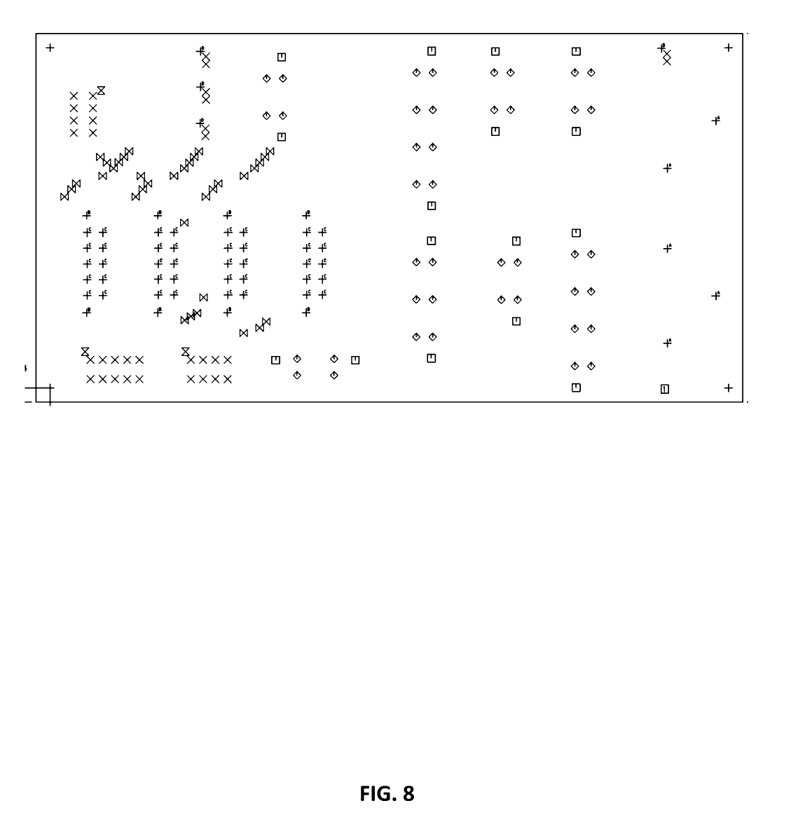

FIG. 8 illustrates holes for connectors by size of a Printed Circuit Board Assembly (PCBA) unit 100 according to the present disclosure.

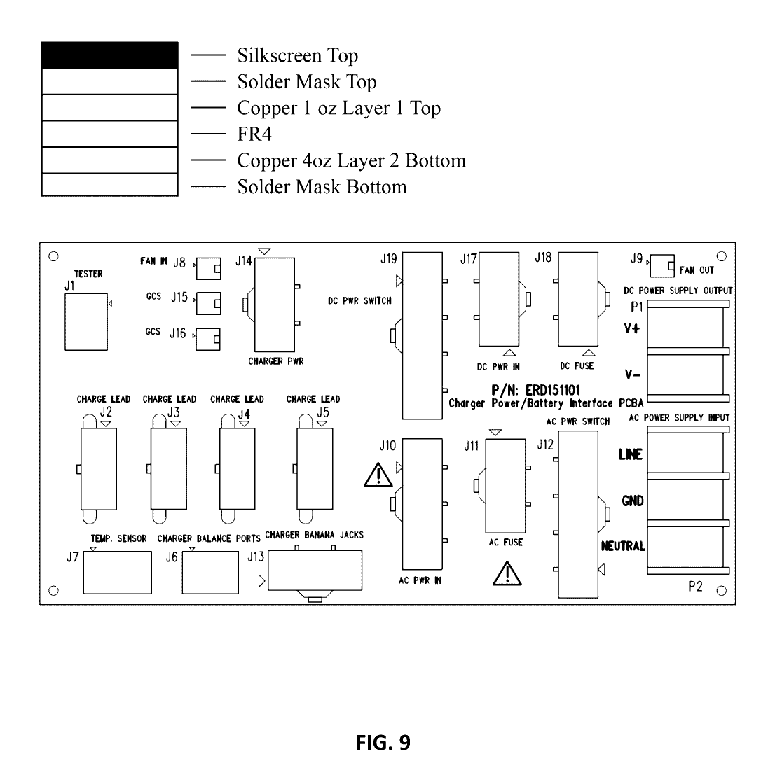

FIG. 9 illustrates a silkscreen top for a PCBA unit 100 according to the present disclosure.

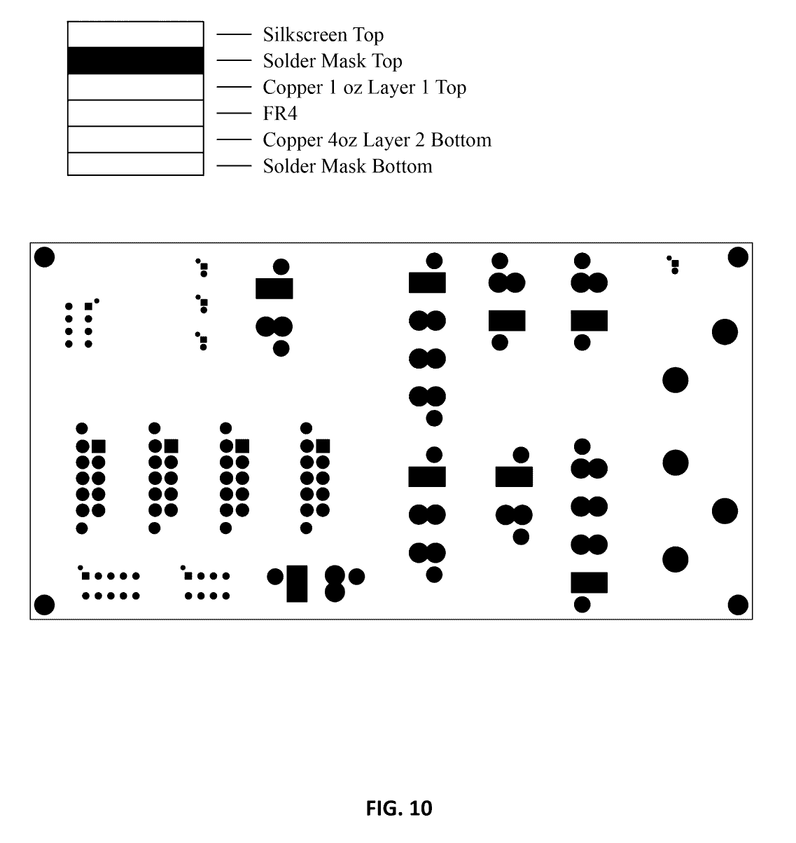

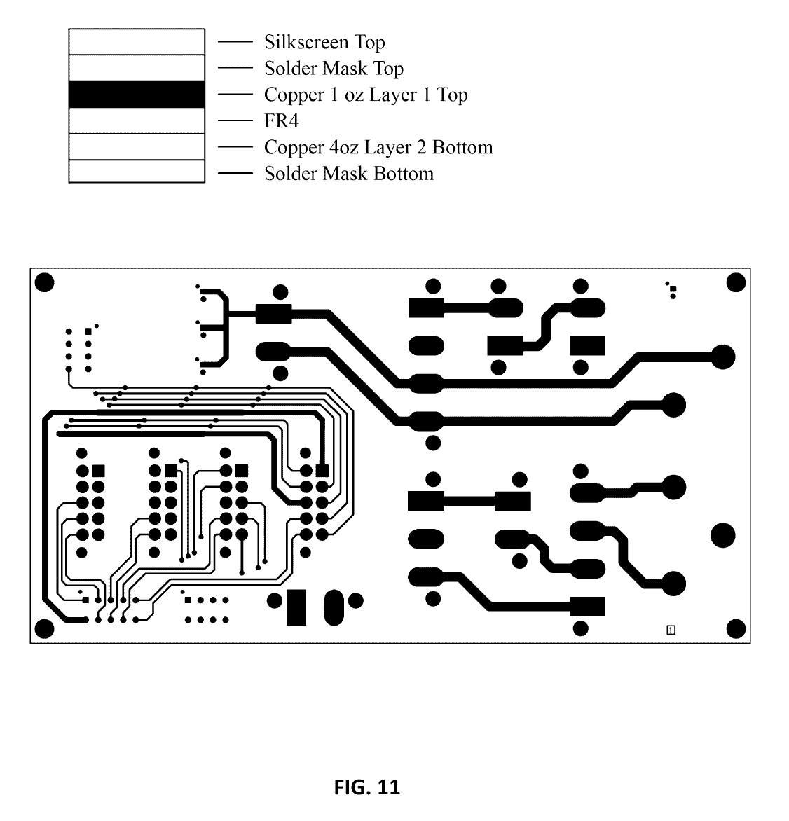

FIG. 10 illustrates a solder mask top for a PCBA unit 100 according to the present disclosure, where black indicates parts that are not solder masked.

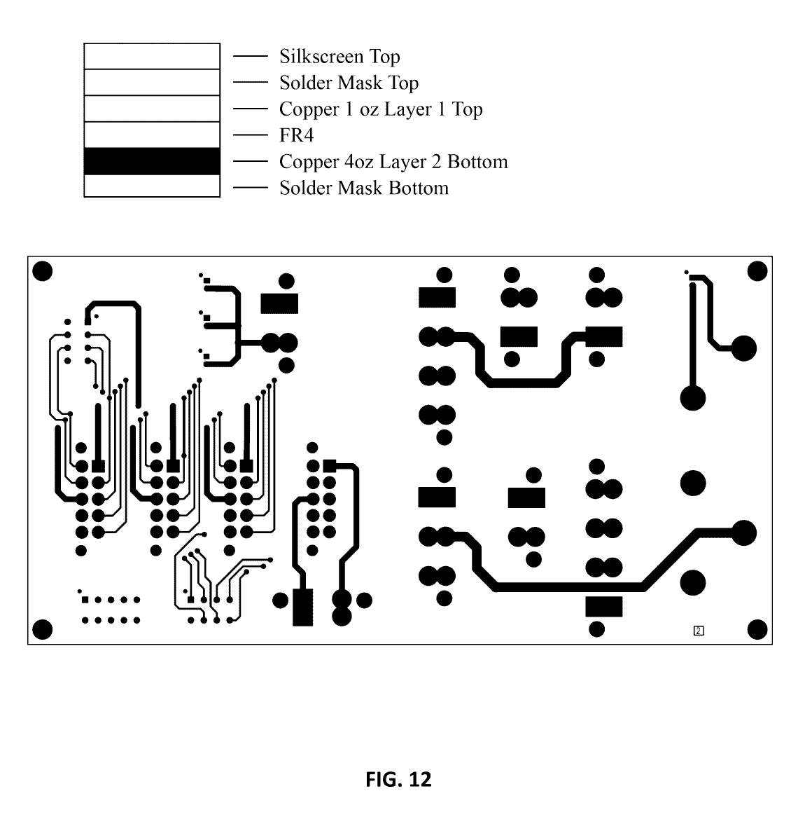

FIG. 11 illustrates a top for a PCBA unit 100 according to the present disclosure.

FIG. 12 illustrates the bottom plan view of a PCBA unit 100 according to the present disclosure.

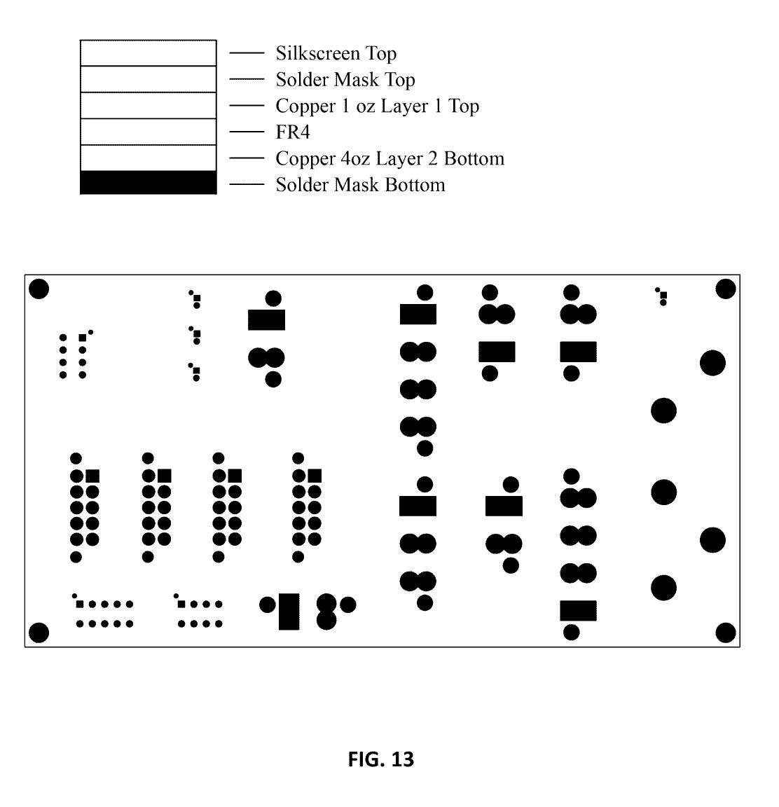

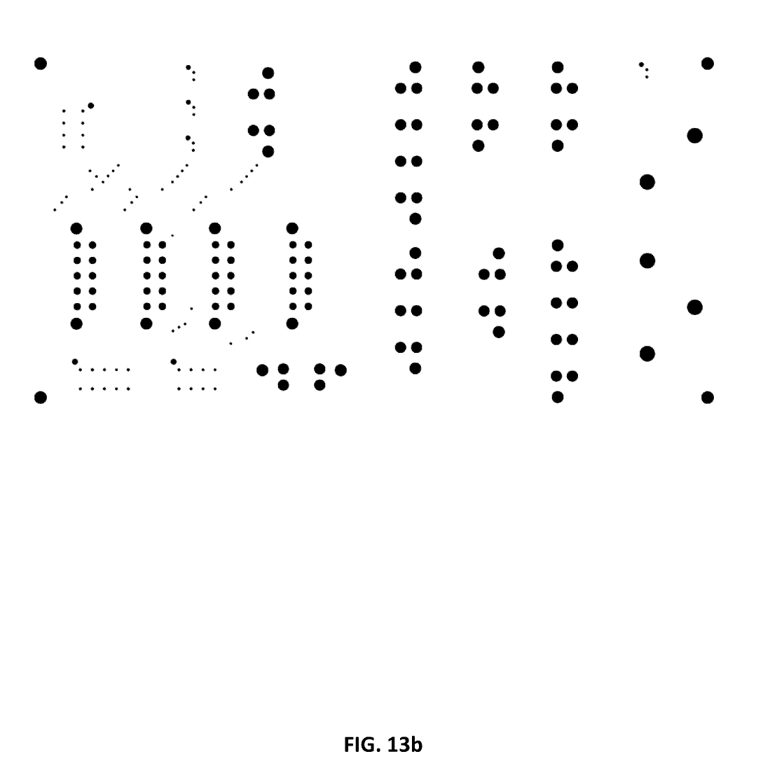

FIG. 13 illustrates a solder mask bottom for a PCBA unit 100 according to the present disclosure, where black indicates parts that are not solder masked.

FIG. 13b illustrates holes in the top of a PCBA unit 100 according to the present disclosure.

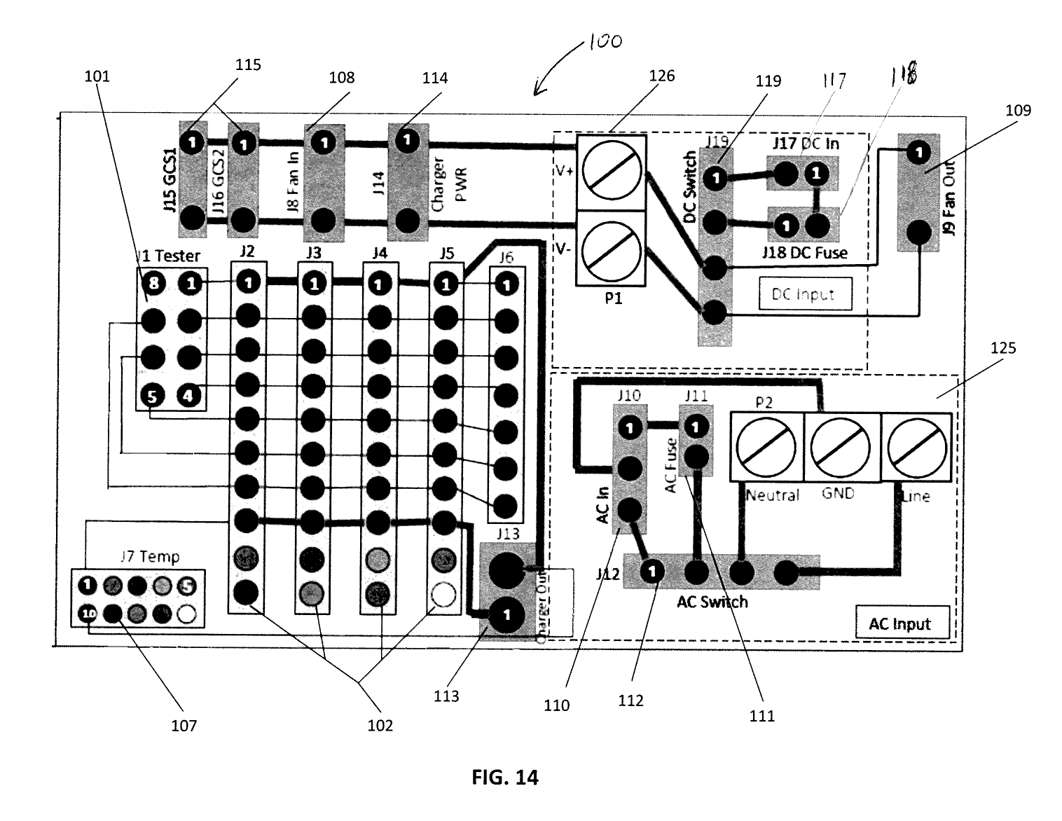

FIG. 14 illustrates the circuit connections of a PCBA unit 100 according to the present disclosure. Similar to FIG. 7, FIG. 14 shows a battery tester 101, four charge leads 102, a temperature sensor 107, an intake fane 108, an outtake fan 109, an AC power input 110, an AC fuse 111, an AC power switch 112, a banana jack port 113, an additional charger port 114, two GCS ports 115, a DC power input 117, a DC fuse 118, a DC power switch 119, a converter AC input 125, and a converter DC output 126.

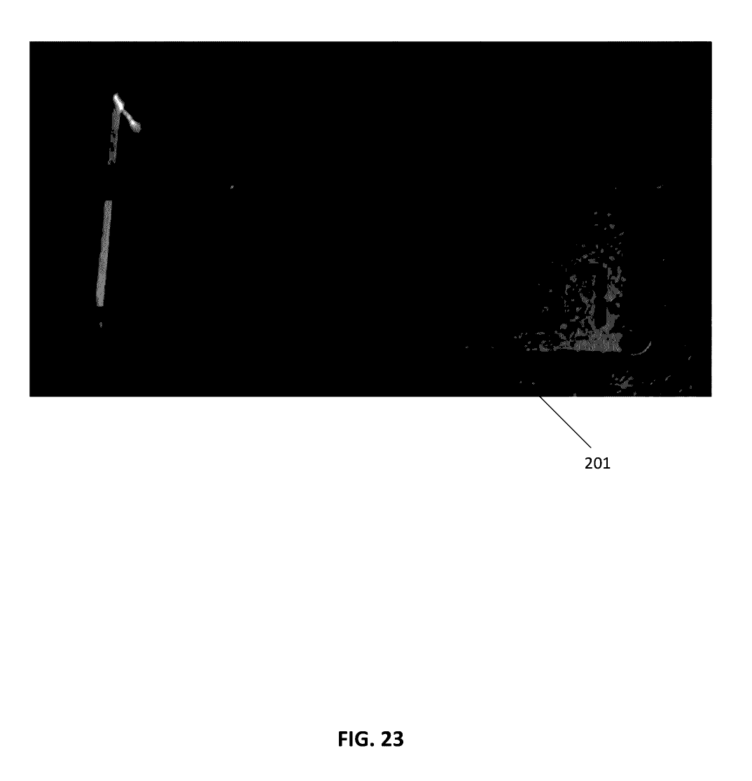

FIG. 15 illustrates a top perspective view of a charging unit 200 according to the present disclosure. In some embodiments, a battery can be first connected to the battery tester 101 to determine the battery type and its status in real time. The tester 101 is powered by the battery that is being tested rather than an internal power source. This is done so that the battery charge level can be detected while the battery is under load, giving a more accurate reading. Once a battery is connected to the tester lead 104, the battery tester 101 gives a reading of the instantaneous voltage of each cell with a precision to two decimal places as well as the charge percentage of each cell within an error of a couple percent. The battery tester 101 can read the overall instantaneous voltage and charge percent of the battery as shown in FIG. 23. It can further determine the present charging status of the battery and the instantaneous draw. In some embodiments, the battery tester 101 can determine the time remaining to fully charge the connected SUAS batteries and/or the time elapsed since charging began. The cells holding the minimum and maximum charges among the cells as well as the composite of the battery (e.g. lithium polymer, lithium ion, etc.) can also be identified. All of this information can then be displayed and cycled through on a tester screen 201 with the tester button 203, such as an LED backlit screen for example, as shown in FIG. 15. The information displayed can be manually cycled. In some embodiments, it can be set to automatically cycle with each screen being presented for a set time. This allows the user to ensure that each cell is functioning properly prior to charging.

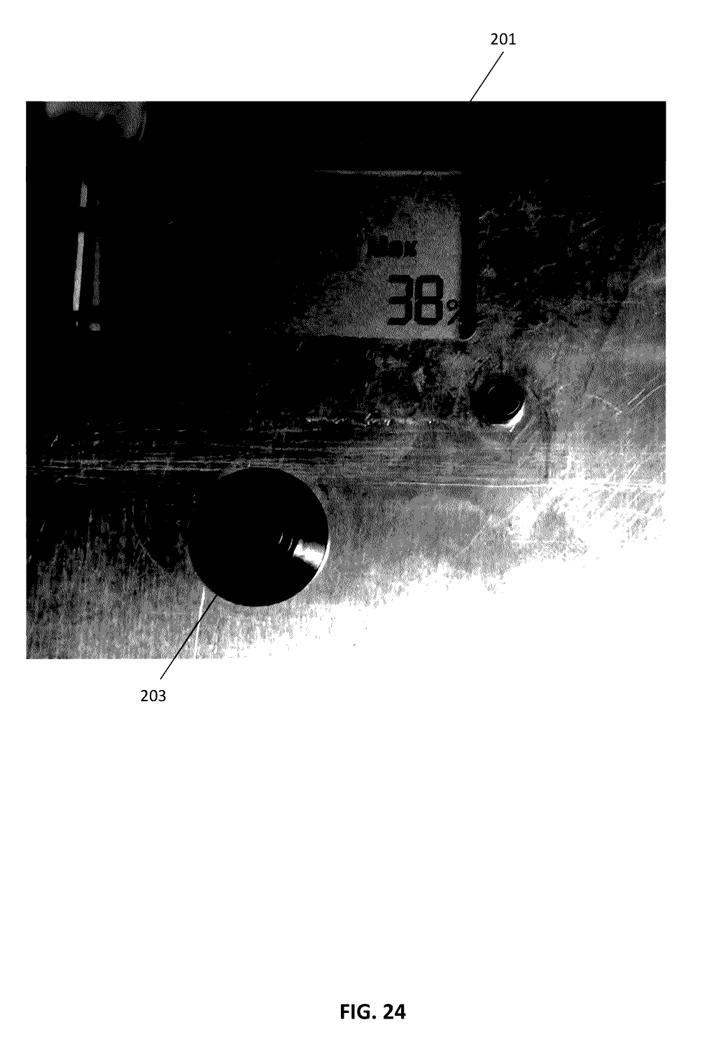

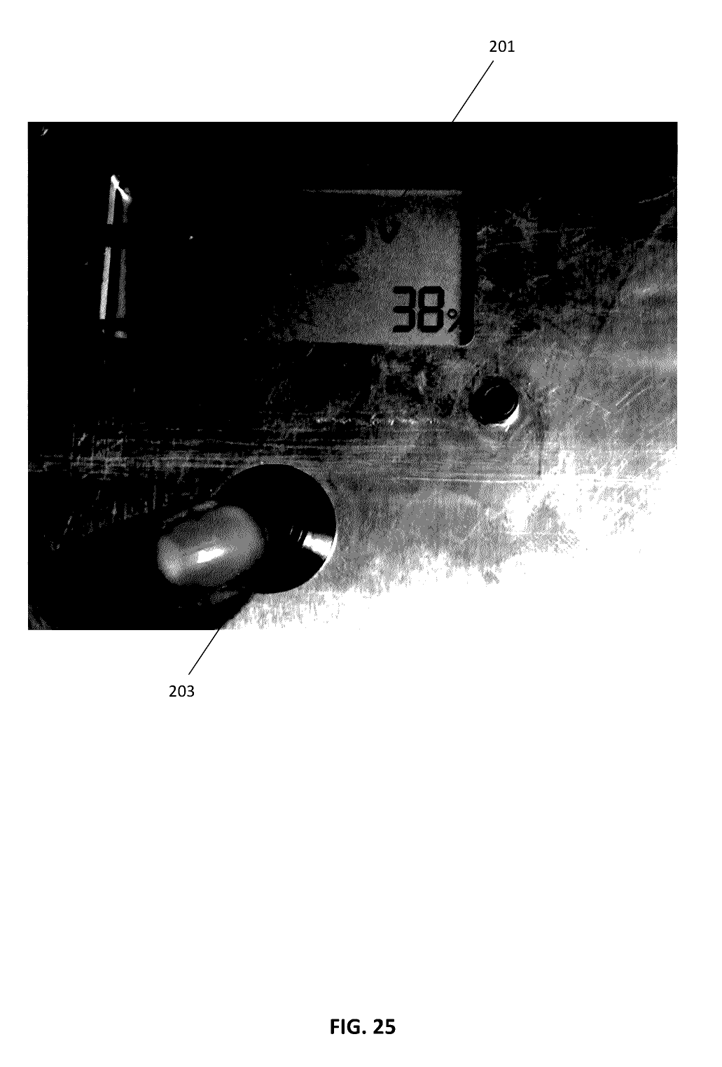

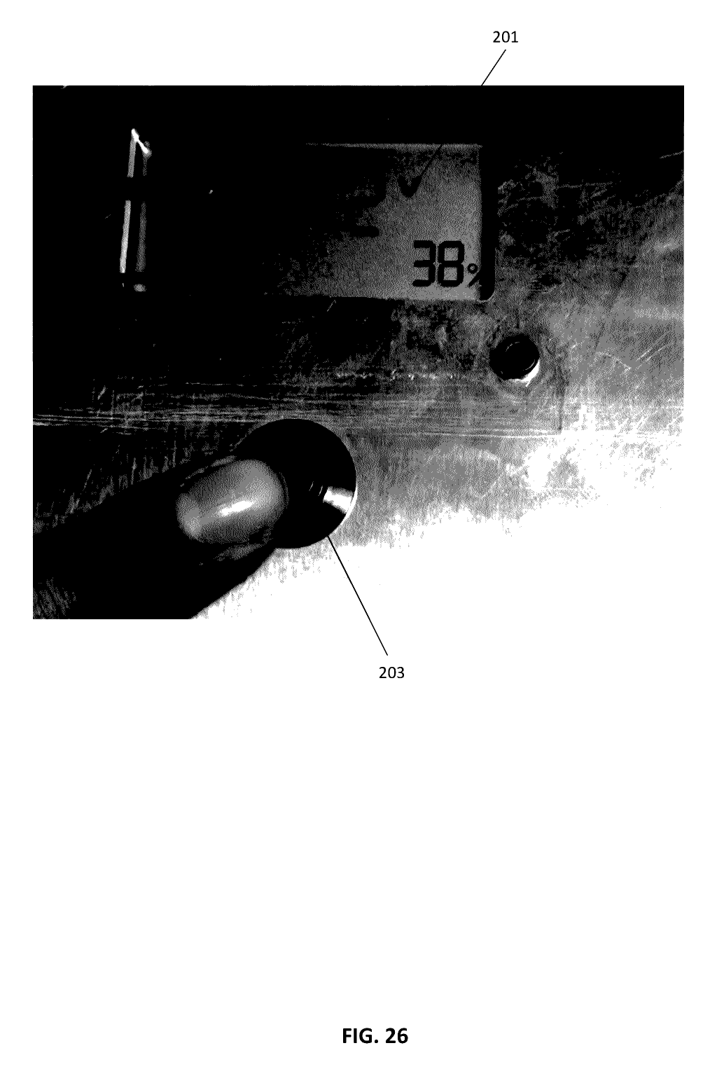

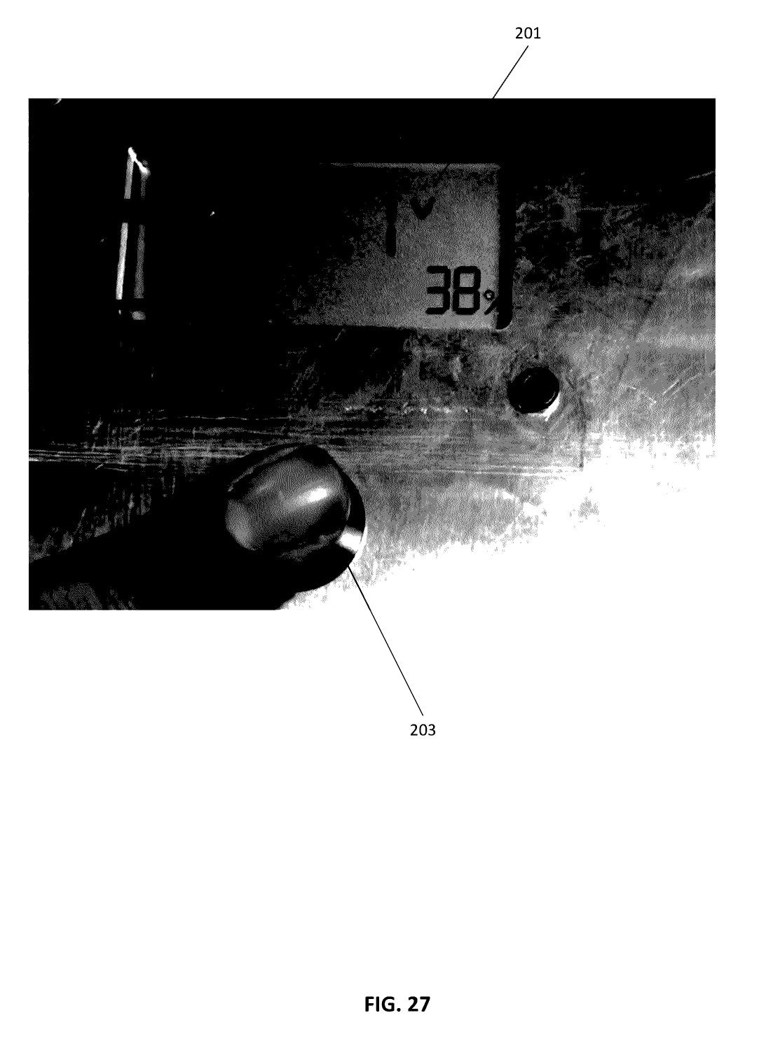

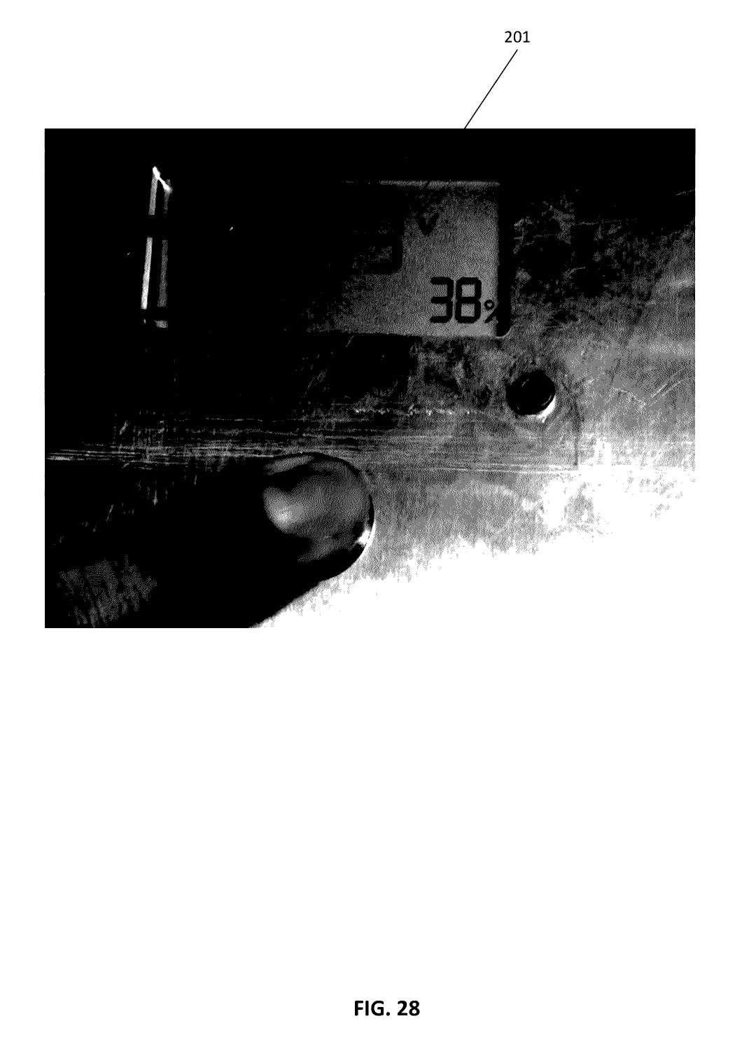

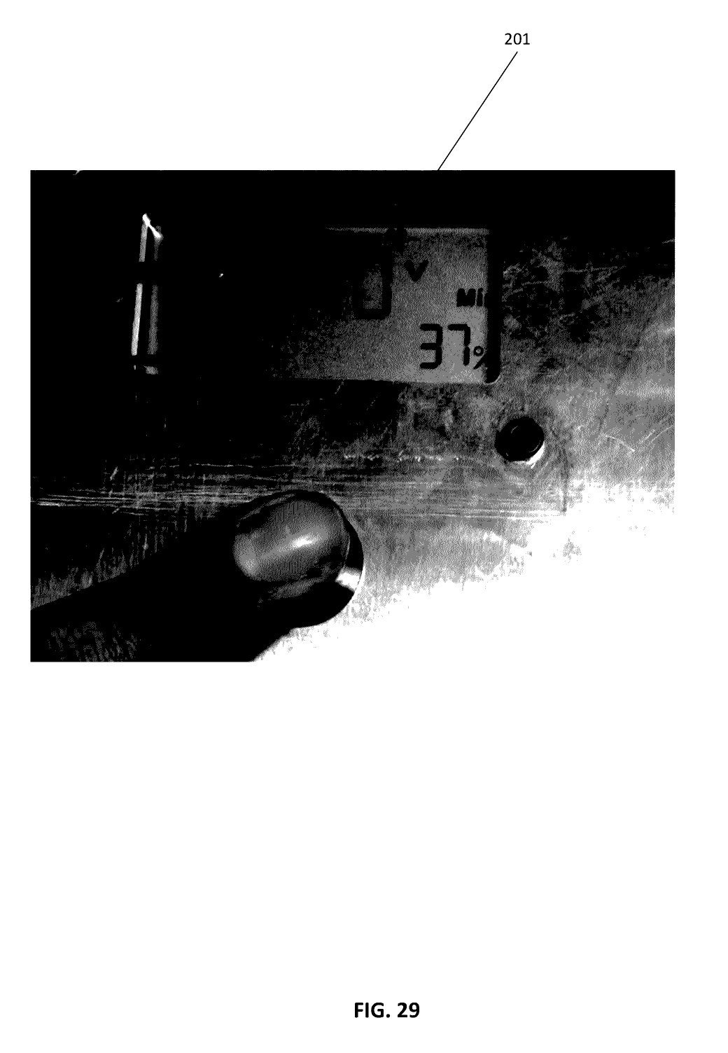

FIGS. 24-29 show displayed on the tester screen 201 each of the six groups of parallel cells in the connected PUMA battery, the voltage and charge percentage of each group of parallel cells, and the type of battery that is connected. Here, the battery type is lithium polymer, abbreviated as “LiPo”. For example, the display in FIG. 24 shows that the first set of cells in series (as identified by “1S”) holds the maximum charge at 38% among the six groups of parallel cells and has a voltage of 3.813 V, and FIG. 29 shows that the sixth set of cells in series holds the minimum charge at 27% and has a voltage of 3.810 Volts.

After testing, the battery is then connected to a charge lead 102. The charge leads 102 can charge SUAS batteries in parallel, such as the Raven or PUMA batteries, or a battery from a VTOL SUAS like the InstantEye, which is a three-cell lithium polymer battery containing three cells in series. Some embodiments have four charge leads 102 each connected to a separate SUAS charge port, allowing four SUAS batteries to charge simultaneously. Other embodiments may have more or fewer charge leads.

The charging unit 200 can select a charge profile that corresponds to the particular battery type of the SUAS batteries connected. Several charge profiles can be preprogrammed into the charging unit, for example, up to 28 different types in one embodiment.

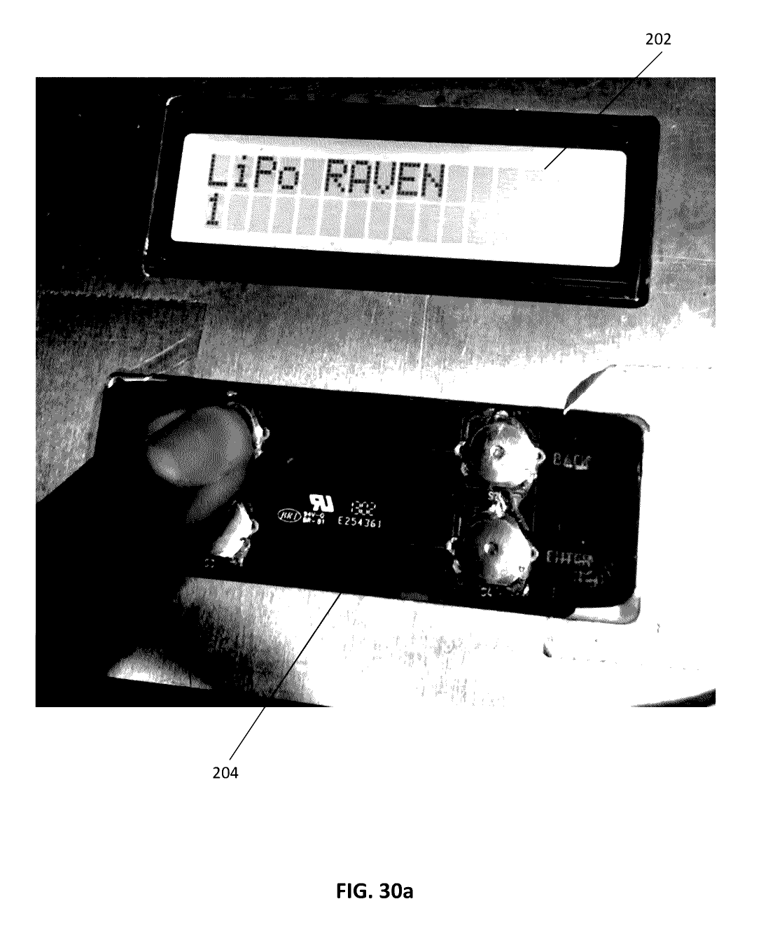

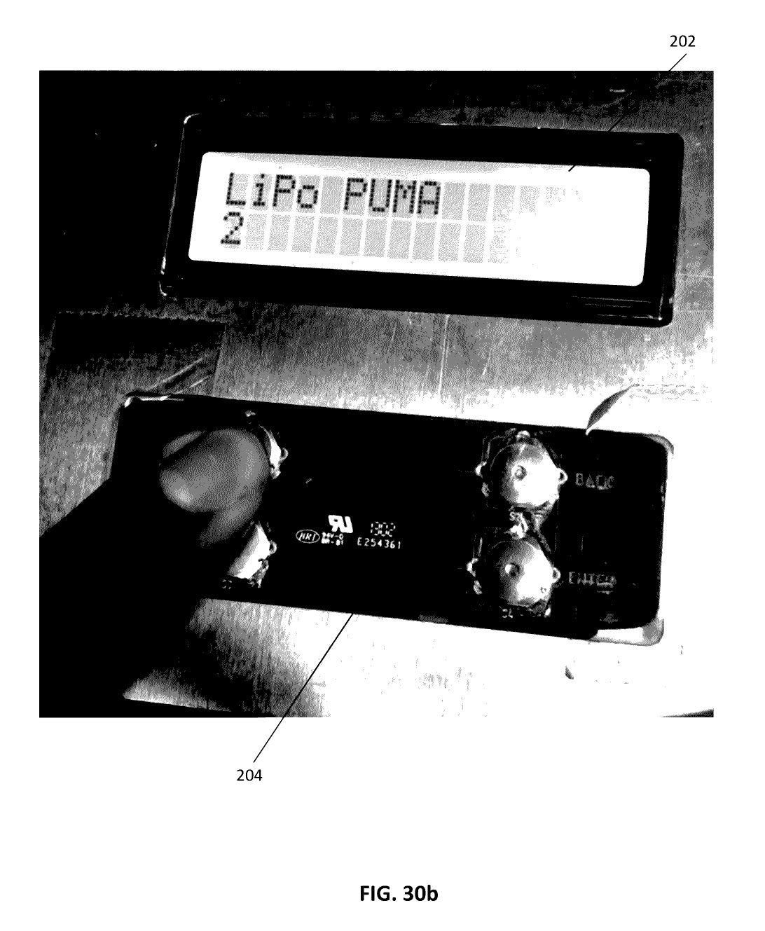

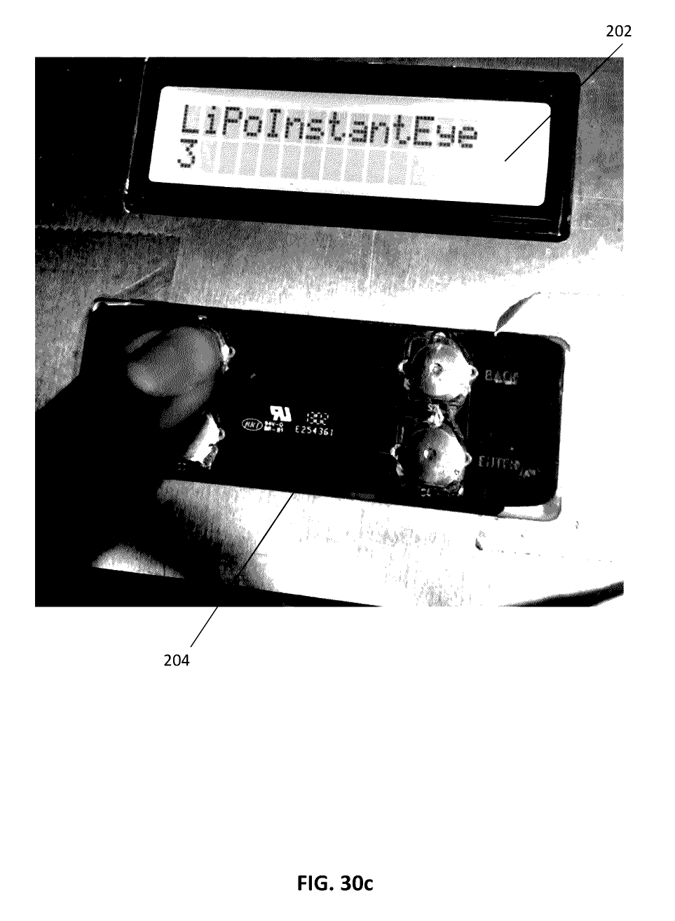

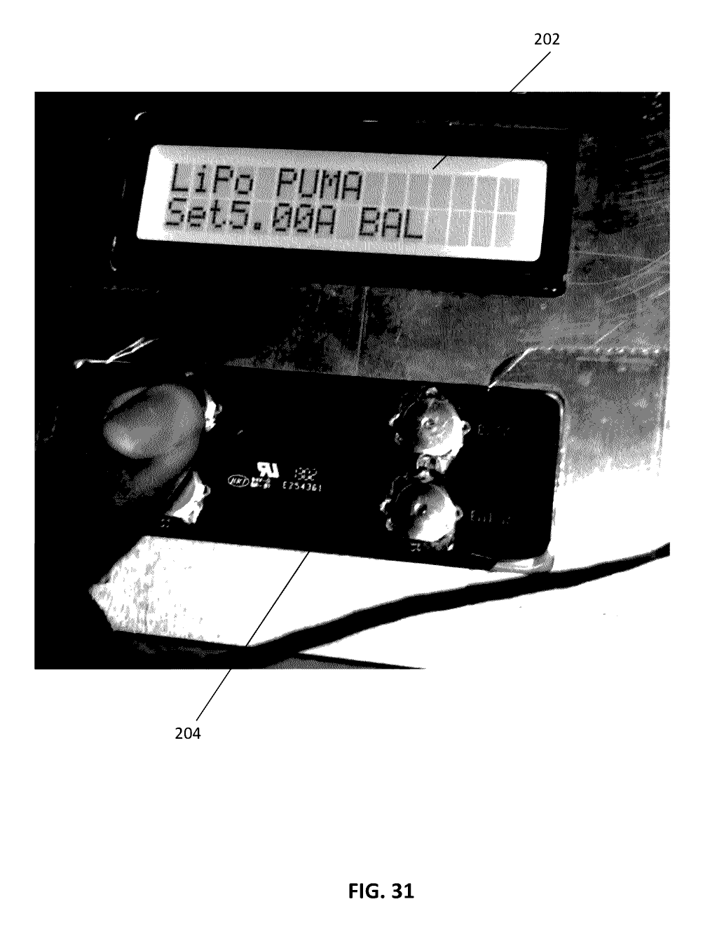

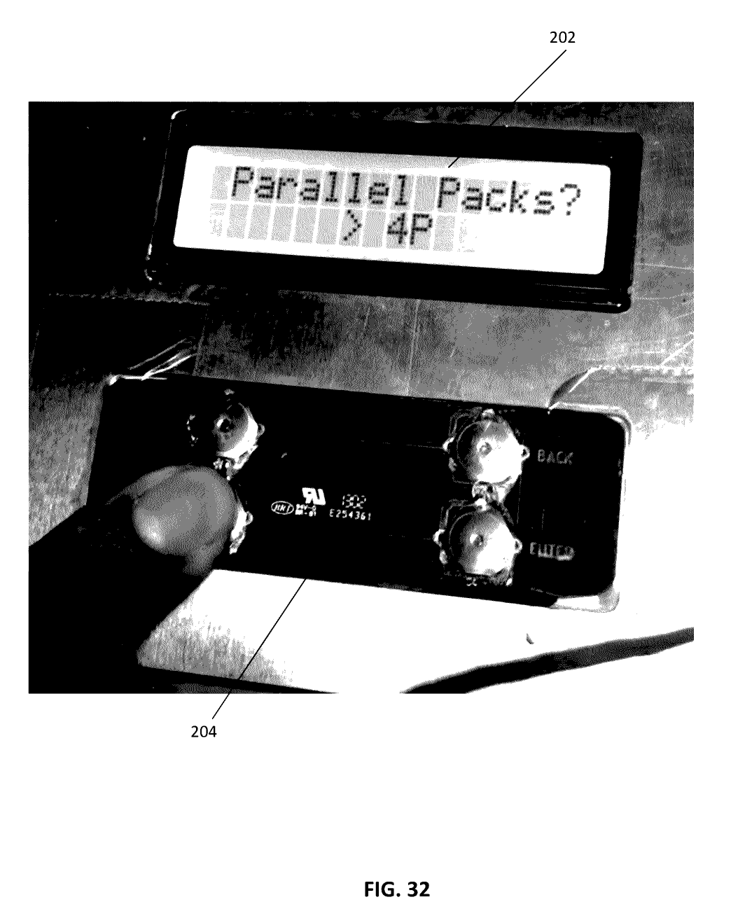

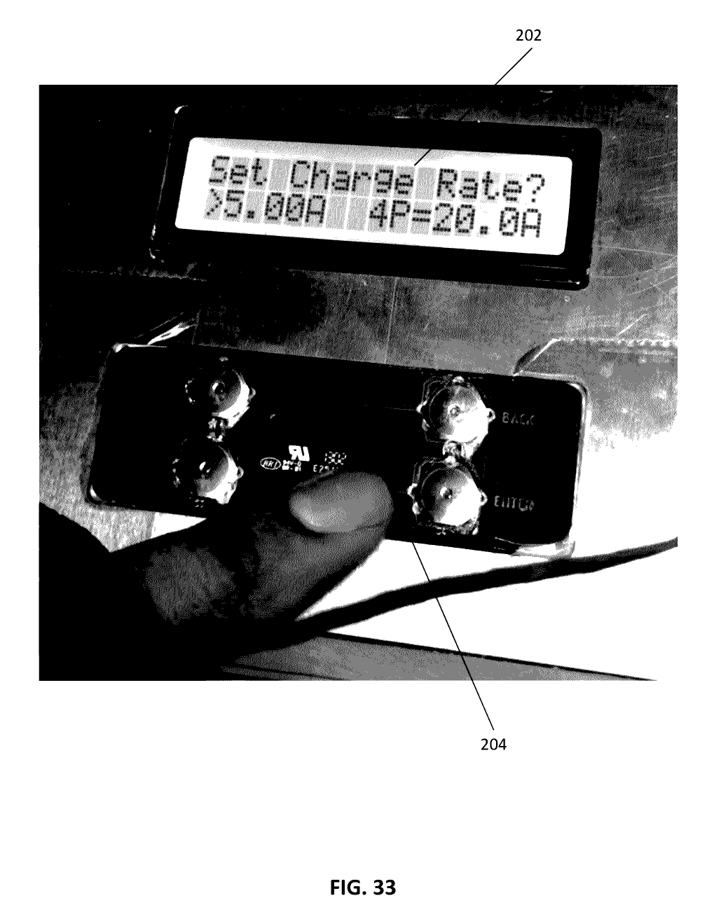

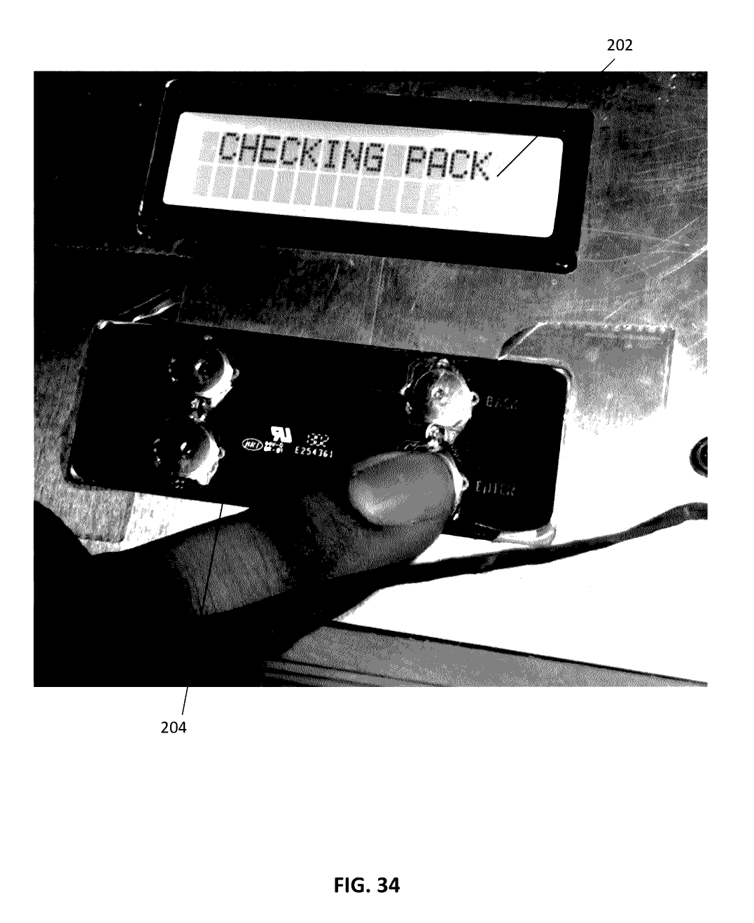

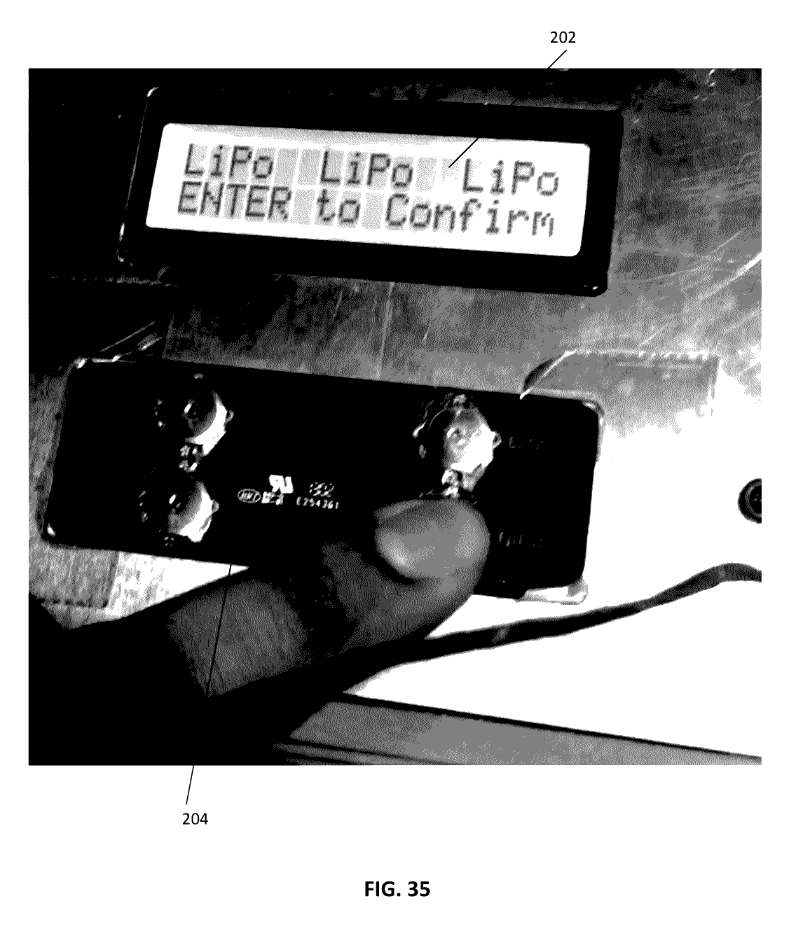

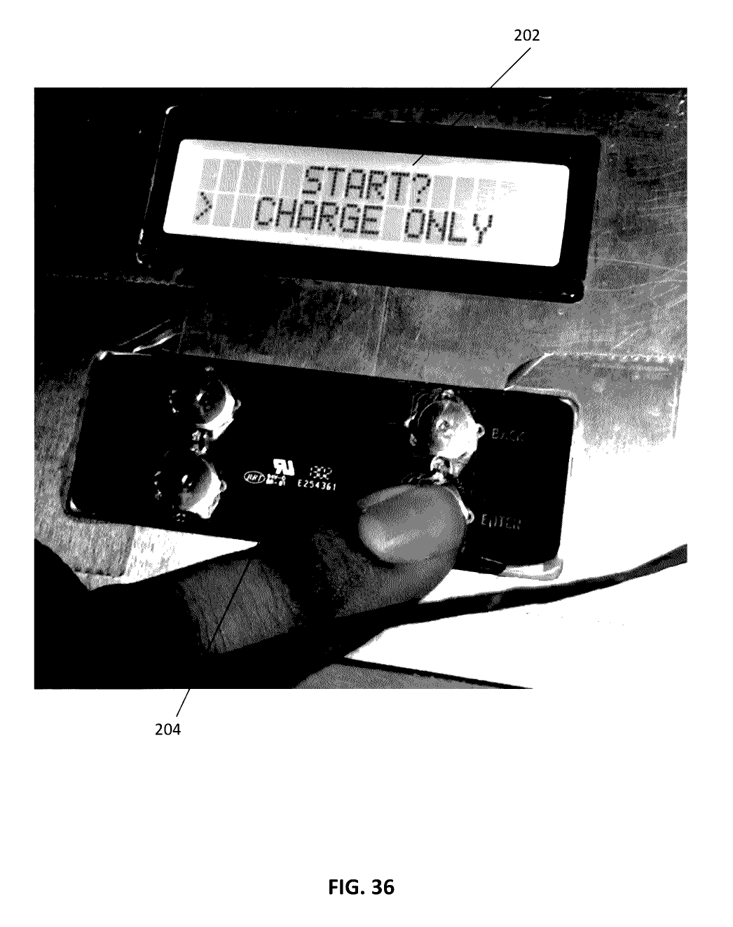

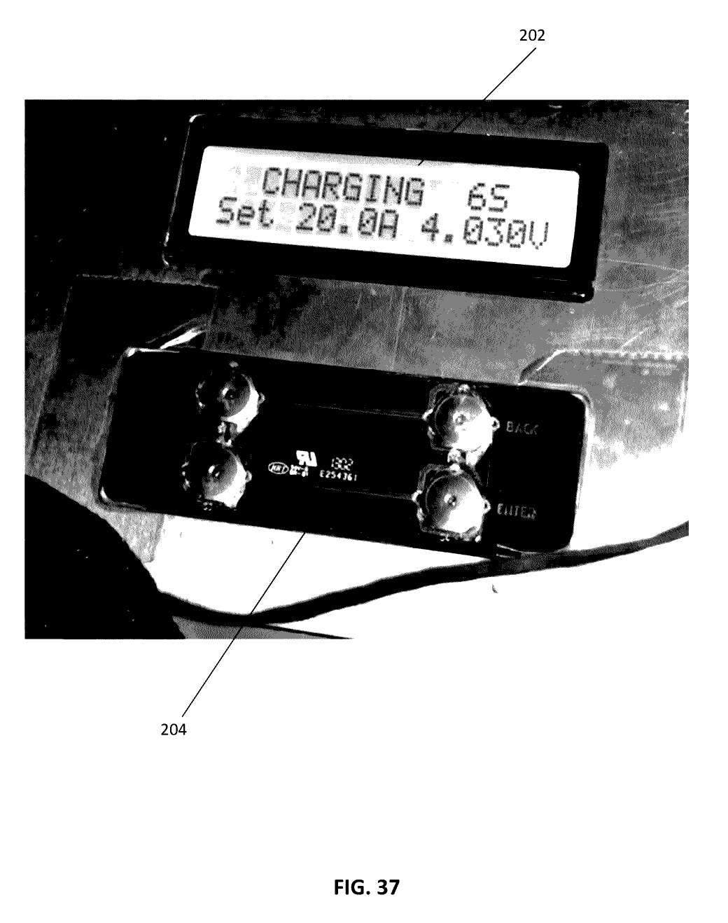

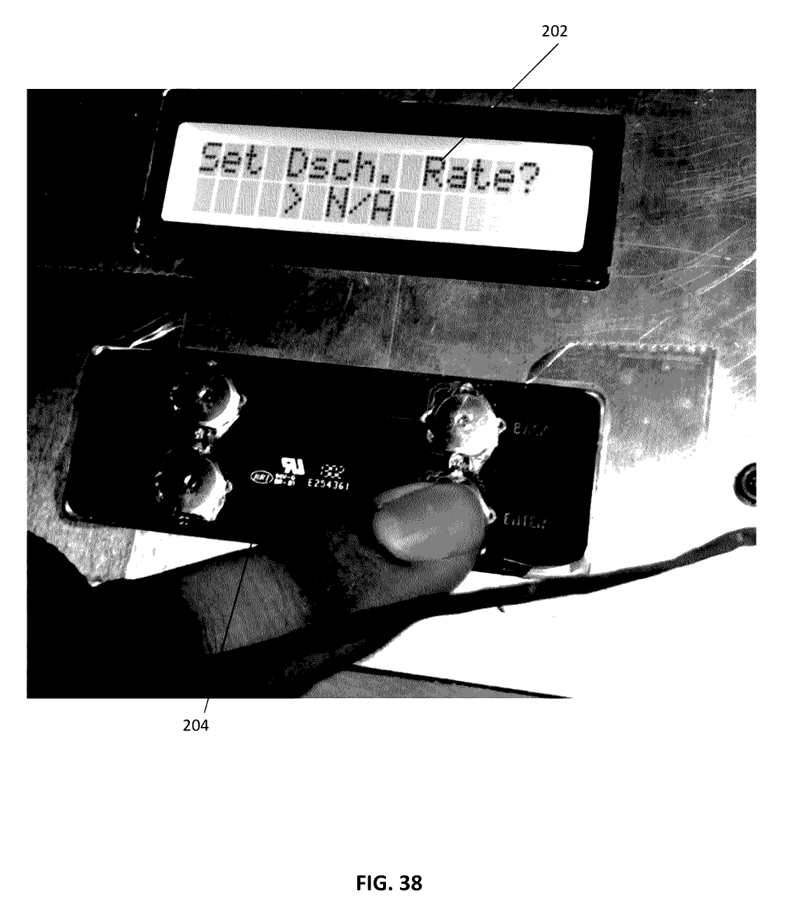

FIGS. 30a-39 show various displays on the charger screen 202. FIGS. 30a-30c display examples on the charger screen 202 of the types of batteries that can be selected, which can be inputted by means of an input device such as, for example, the charger key pad 204. Other means of inputting the battery type can be used such as a touch screen or an alphanumeric touchpad. The battery model is then selected to determine the settings for the charge based upon the preprogrammed charge profile associated with the battery type. In some embodiments, the user can create or edit the programmed charge profiles. The number of batteries being charged in parallel is then selected by the user. FIG. 32 shows an example of a display when 4 batteries are being selected to charge simultaneously. In some embodiments, the pin connectors 103 relay to the charging unit 200 which charge leads are connected to batteries to allow the charging unit to automatically determine the number of batteries being charged. FIG. 34 shows a display on the charger screen 202 when the battery is being checked to ensure all cells are properly functioning. FIG. 35 shows a display of the battery model selected being confirmed. The current to each battery and the total current are also confirmed, and then the charging unit begins charging. In FIG. 36, the charger screen 202 displays confirmation to begin the process selected, which is to charge the batteries in this example. The charger screen 202 can be a digital screen, for example, or various other output display devices. While charging, the instantaneous current and voltage can be displayed in real time as shown in FIG. 37. Some embodiments also allow the user to override the charge profile and select the desired amount of current and voltage applied.

In some embodiments, the charging device can have three settings: charge, discharge, and storage. These charge settings have been discussed herein. The discharge setting allows SUAS batteries to be discharged when connected to a charge lead 102. In some embodiments, multiple batteries can be simultaneously discharged. The storage setting automatically charges/discharges the SUAS batteries to a 50% charge, which is an acceptable charge for long-term storage of batteries. The storage setting may also be programmed to other storage charge levels. Each cell within the battery is charged or discharged, depending on its initial status, to reach the programmed charge level.

In some embodiments, a Near Field Communication System, or “bump controller”, is incorporated to identify the type of battery. The charger includes a reader and each battery contains an identifier, for example an RFID tag, that can be read by the reader. A database or look-up table containing identification information may be linked to the charger to recognize the type of battery from the information gathered from the identifier. The charger can then automatically set the charge profile to correspond to the type of battery detected. Thus, with the bump controller, the battery can “bump” into the reader, eliminating the need for manual selection of the battery type. Depending on the particular embodiment, “bumping” may be accomplished by physically contacting the battery or other object to be sensed to a sensing area on the charger or by bringing the battery/object into proximity with the reader.

In some embodiments, the charging begins with constant voltage to stabilize the charge, and then charging continues with constant current. The charger screen 202 can display the instantaneous voltage and total current that is being applied to the batteries, the battery type of SUAS battery (e.g. PUMA, Raven, or InstantEye), and the elapsed time since the charging began.

The additional charger port 114 shown in FIG. 7 is a USB port 214 in FIG. 15, but may be configured to a different type of port. In one embodiment, the additional charger 114 outputs 5 volts and is capable of charging batteries used in conjunction with SUAS, such as tablet computers, e.g., the PocketDDL tablet Remote Video terminal. The additional charger port 114 is powered on a circuit separate from the charge leads 102 circuit and the GCS ports 115 circuit. Here, the additional charger port 114 is connected to an auxiliary cable from the AC/DC converter 216 and, therefore, is only operational when the power supply is AC. In another embodiment, the additional charger port 114 may be connected in a way to operate with either an AC or DC power supply.

As shown in FIG. 15, the AC power input 110 receives a three-prong plug from an AC power source, such as a wall electrical outlet. This embodiment includes an AC fuse 111 that is a military-specification (MIL-SPEC) fuse with a push button to reset a thrown fuse. However, various types of switches may be used for the fuse, such as a toggle switch. The DC power input 117 receives a connection to a DC power source, such as a Humvee battery, for example, or any external battery that provides 10-48 volts. The DC fuse 118 is a military-specification (MIL-SPEC) fuse like the AC fuse 111 and can similarly be reset with the push of a button. This allows for the fuses to quickly and easily be reset while in the field. The AC power switch 112 and the DC power switch 119 are MIL-SPEC toggle switches with on or off options to access the AC power source and DC power source, respectively, but other types of switches may also be employed.

FIG. 15 shows a mesh covering over the intake fan 108 and the outtake fan 109, but the fans can be covered in numerous ways including with a metal or plastic grille. As discussed above, the charging unit 200 further includes GCS ports 115.

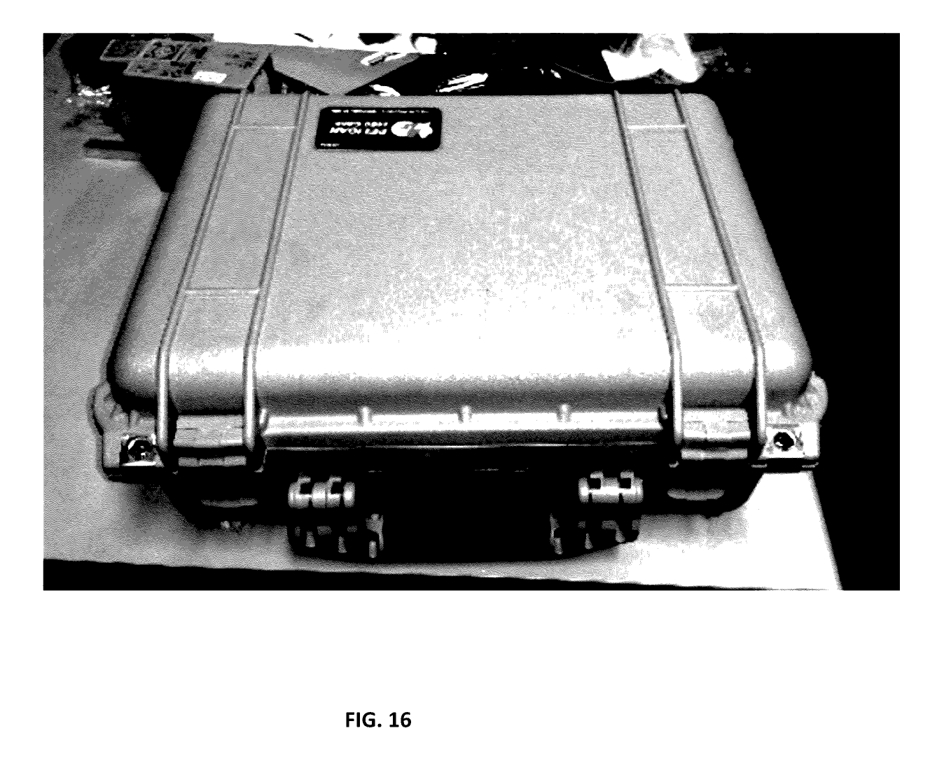

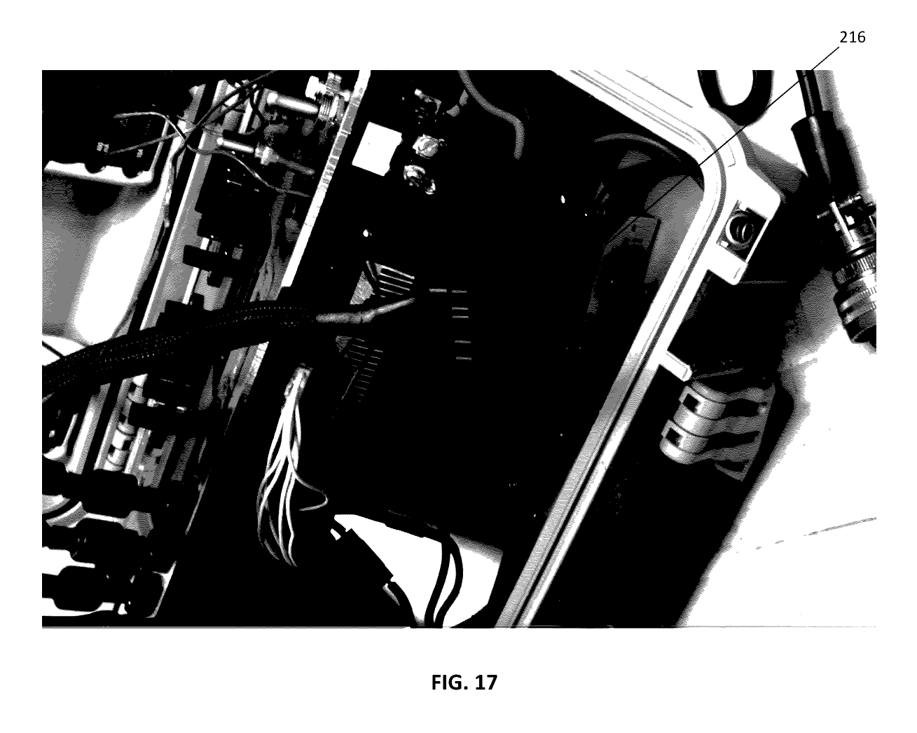

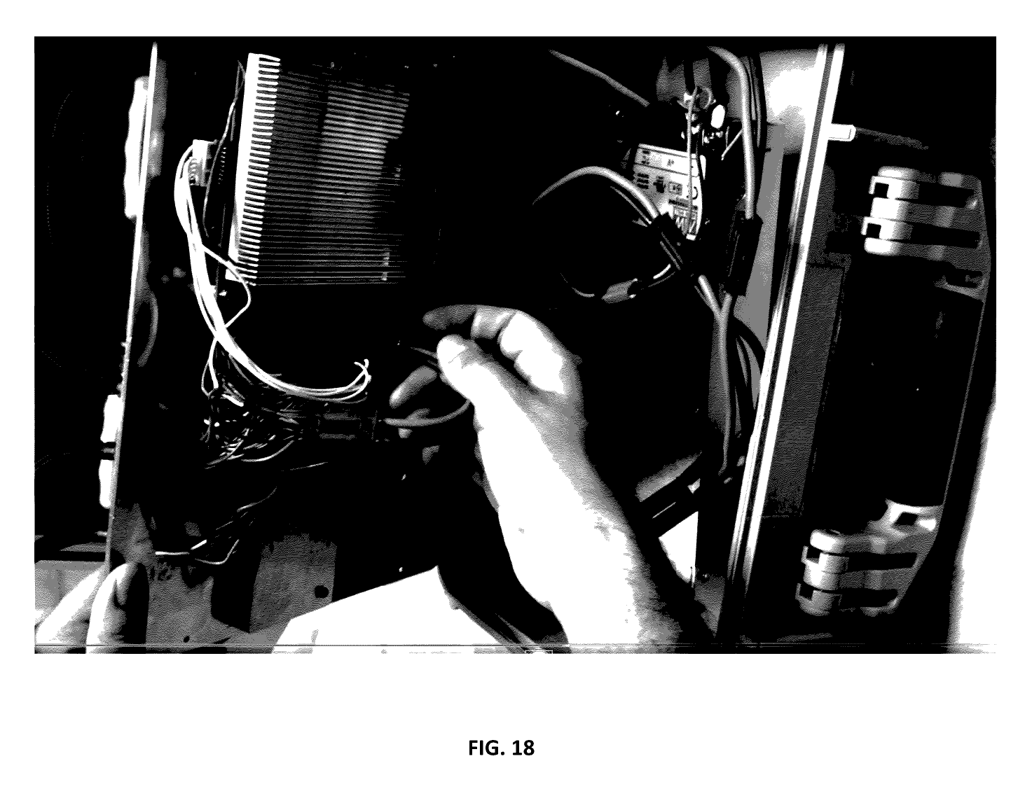

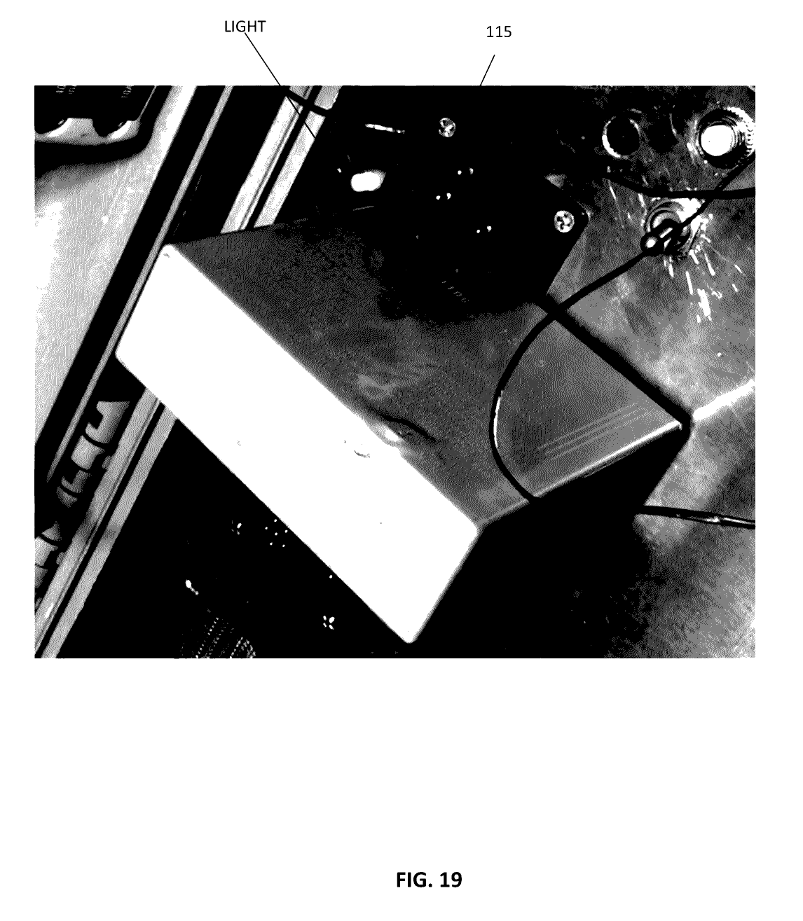

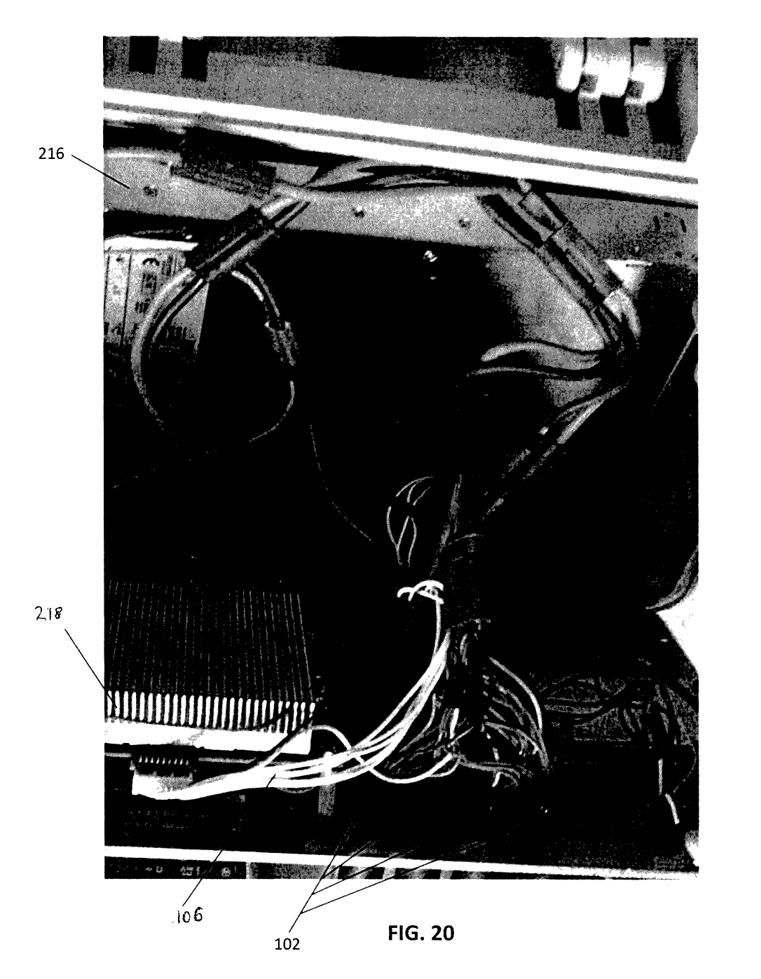

FIG. 16 illustrates a closed carrying case containing a charging device according to the present disclosure. FIGS. 17-21 show different views of a charging device according to the present disclosure within a carrying case. In some embodiments, the charging device can be sized and arranged to fit into a carrying case for easy transport, such as a MIL-SPEC case. FIG. 17 shows an AC/DC converter 216. FIG. 20 also displays an AC/DC converter 216 as well as a heat sink 218, charge leads 102, and charger balance ports 106. FIG. 21 provides another view of the heat sink 218 and the AC/DC converter 216.

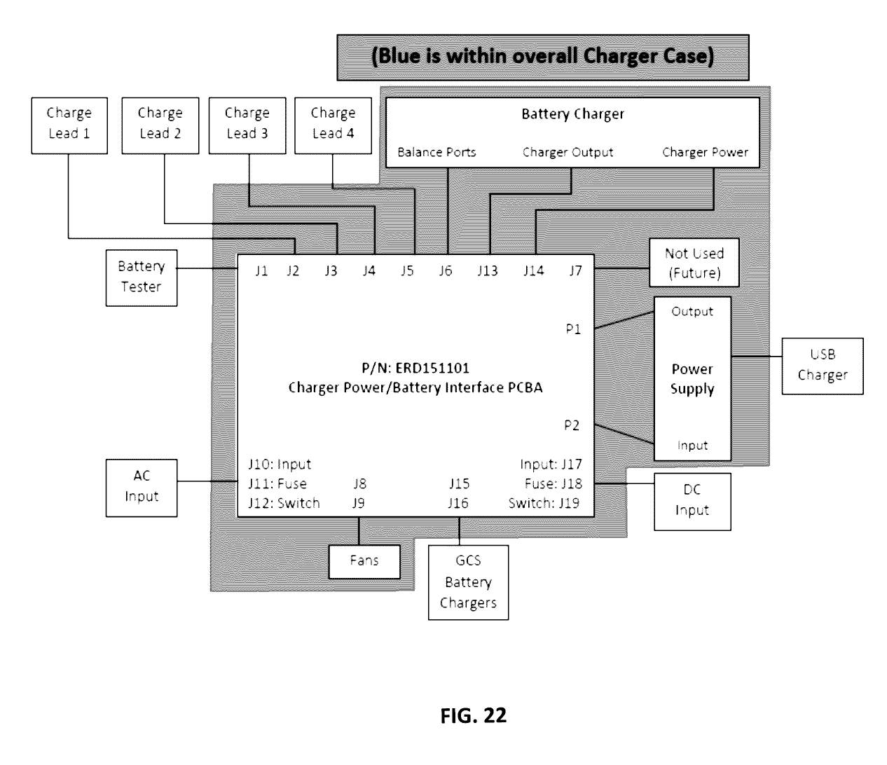

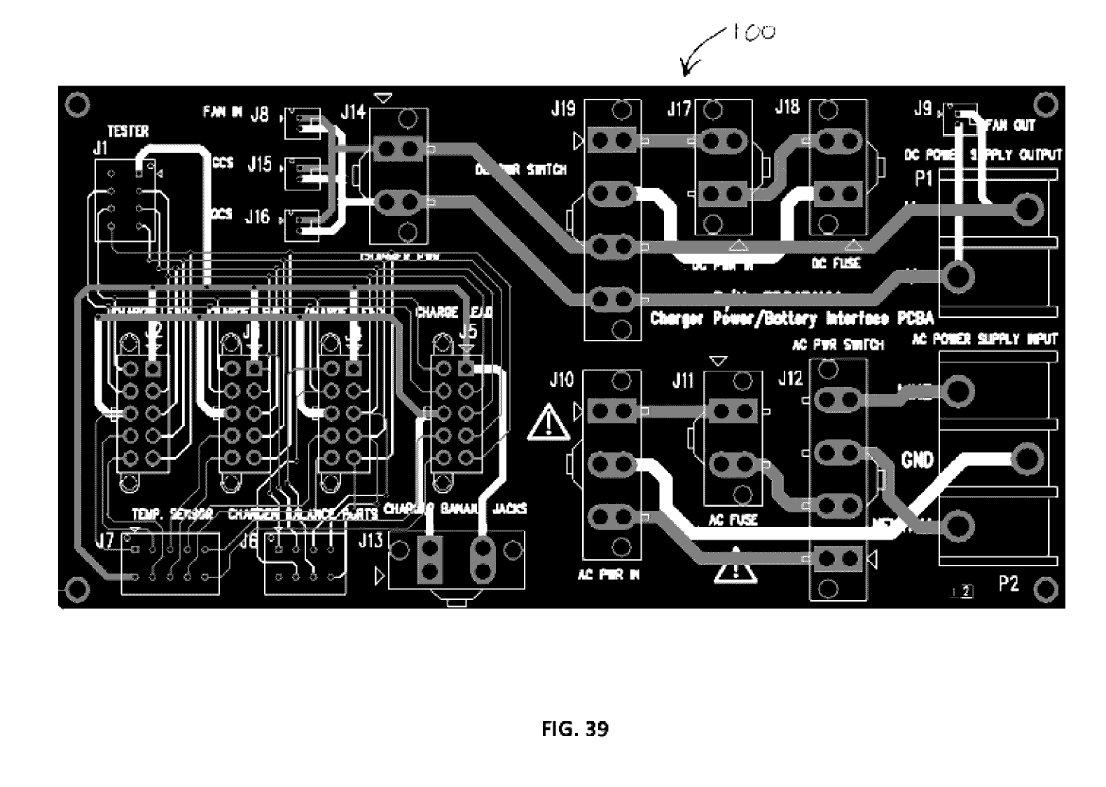

FIG. 22 illustrates a block diagram of a charging device according to the present disclosure. FIG. 39 illustrates both sides of a PCBA unit 100 that may be used in embodiments of the charging unit.

Although the present invention has been described in detail with reference to certain configurations thereof, other versions are possible. Embodiments of the present invention can comprise any combination of compatible features described in the specification or shown in the various figures, and these embodiments should not be limited to those expressly illustrated and discussed. Therefore, the spirit and scope of the invention should not be limited to the versions described above.

We claim:

1. A charging unit for unmanned aircraft systems (SUAS), comprising:
a plurality of SUAS charger ports in parallel with each other and configured to connect to SUAS batteries; and
at least one ancillary charging port;
wherein said plurality of SUAS charger ports is capable of charging at least three SUAS batteries simultaneously.

2. The charging unit of claim 1, wherein each of said plurality of SUAS charger ports outputs a power of about 1200 Watts or greater.

3. The charging unit of claim 1, wherein said plurality of charging ports are configure to connect to vertical take-off and landing SUAS batteries.

4. The charging unit of claim 1, wherein said at least one ancillary charging port are ground control station ports.

5. The charging unit of claim 1, further comprising a tester lead configured to test a SUAS battery voltage and charge percentage.

6. The charging unit of claim 1, further comprising a heat sink in thermal contact with said plurality of SUAS charger ports.

7. The charging unit of claim 6, further comprising an intake fan and an outtake fan.

8. The charging unit of claim 1, further comprising an additional charger port on an independent circuit.

9. The charging unit of claim 1, wherein said plurality of SUAS charger ports are configured to be powered by a DC power source or an AC power source.

10. A charging unit for small unmanned aircraft systems (SUAS) and ancillary components, comprising:
at least three SUAS charger ports in parallel with each other and each configured to connect to a SUAS battery; and
at least one ancillary charger port, each of said ancillary charger ports on independent circuits;
wherein said plurality of SUAS charger ports is configured to charge said SUAS batteries simultaneously.

11. The charging unit of claim 10, wherein each of said plurality of SUAS charger ports outputs a power of about 1200 Watts or greater.

12. The charging unit of claim 10, wherein said charging unit is capable of simultaneously charging at least four SUAS batteries.

13. The charging unit of claim 10, wherein said at least one ancillary charger port are at least one ground control station port.

14. The charging unit of claim 13, wherein said at least one ancillary charger port further comprises an additional charger port on an independent circuit.

15. The charging unit of claim 10, further comprising a tester lead configured to test a SUAS battery voltage and charge percentage.

16. The charging unit of claim 10, further comprising an intake fan and an outtake fan.

18. The charging unit of claim 10, wherein said plurality of SUAS charger ports is configured to be powered by a DC power source and an AC power source.

19. An unmanned aerial vehicle system, comprising:
an unmanned aerial vehicle; and
a charging system comprising:
at least three charging ports each configured to charge an unmanned aerial vehicle battery; and
at least one ground control station (GCS) port each configured to charge a GCS battery;
wherein said plurality of charging ports can operate simultaneously, each of said plurality of charging ports outputting a power of about 1000 Watts or greater.

20. The unmanned aerial vehicle system of claim 19, wherein said plurality of charging ports can be powered by a DC power source and an AC power source.
